(19) United States
(12) Patent Application Publication
(10) Pub. No.: US 2023/0263183 A1
(43) Pub. Date: Aug. 24, 2023

(54) METHOD FOR ROASTING COFFEE BEANS

(71) Applicant: SOCIETE DES PRODUITS NESTLE S.A., Vevey (CH)

(72) Inventors: FLAVIEN FLORENT DUBIEF, Linwood, NJ (US); NICOLAS BIGLER, Morrens (CH)

(21) Appl. No.: 18/006,773

(22) PCT Filed: Jul. 27, 2021
(86) PCT No.: PCT/EP2021/070980

§ 371 Date: Jan. 25, 2023

(30) Foreign Application Priority Data
Jul. 28, 2020 (EP) 20188216.4

(51) Int. Cl. A23F 5/04; A23N 12/12

(52) U.S. Cl. CPC A23F 5/04; A23N 12/125

(57) ABSTRACT

The invention concerns a method to determine the recipe Rym for roasting a quantity m of a type Cy coffee beans in a particular type of roasting apparatus, said recipe Rym providing setpoints (Tym@ti; ti), wherein the method comprises the steps of:—getting access to: ⋅a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and to at least one pre-determined original roasting recipe RyMoriginal adapted to the roasting of one original pre-determined quantity Moriginal of the type Cy coffee beans, and—based on the comparison between m, the accessible original pre-determined quantity Moriginal and the accessible pre-determined quantities of the list (M, M±Δx), determining the roasting recipe Rym to be applied on said quantity m of coffee beans.

### FIELD OF THE INVENTION

The present invention relates to the roasting coffee beans and more specifically to the roasting of different quantities of coffee beans, particularly suited for use in the home or in shops and cafes.

### BACKGROUND OF THE INVENTION

For the last decades, numerous roasters have been developed for use in the home or in small shops and coffees. Most of the roasters are based on fluidized bed technology implementing a hot air fluid bed chamber. Within such a chamber, heated air is forced through a screen or a perforated plate under the coffee beans with sufficient force to lift the beans. Heat is transferred to the beans as they tumble and circulate within this fluidized bed.

Derived from an industrial roaster described in U.S. Pat. No. 3,964,175, this technology has been adapted in small domestic devices like U.S. Pat. Nos. 4,484,064, 4,494,314, 4,631,838, 4,968,916, 5,269,072, 5,564,331, . . . and today, most of these roasters implement automatic roasting processes with predefined roasting profiles stored in the control unit of the apparatus. These predefined roasting profiles are usually defined for a particular type of coffee beans and by a coffee expert. They are defined to provide the optimal roasting of each type of coffee beans and reproducing the roasting profile is a guarantee of always getting the same final roasted beans that is consistency.

Whereas the roasting chamber of home devices is usually sized to hold a small quantity of coffee beans that is systematically filled at each roasting operation, devices for small shops and coffees are usually sized at an upper scale enabling the operator to roast beans for a large or a small number of consumers alternatively, depending on the demand. For example, the roasting chamber can be sized to enable the roasting of a quantity of coffee beans ranging from 50 g to 300 g.

The roasting parameters—essentially time and temperature—cannot be the same for different quantities of beans to be roasted. Otherwise, when the quantity of beans diverts significantly from the standard usual quantity, the quality of the roasting can be adversely affected: beans can become burnt or the desired degree may not be reached or the beans may not be uniformly roasted, or may not provide the optimal sensory profile. Consistent roasting is not obtained although the beans to be roasted and the roasting apparatus are the same.

US 2004/074400 describes a roasting apparatus wherein the roasting parameters can be adapted depending on weights and types of beans. In particular, a standard roasting curve can be adapted based on the weight of coffee beans introduced inside the roaster. Yet it is not explained what this standard roasting curve represents and how it is adapted to different types of beans.

US 2014/0314923 describes a roasting apparatus wherein roasting profiles are stored and wherein the controller is operative to calculate an optimum roasting profile based upon information concerning coffee to be roasted like weight and type of beans. Yet no description of this calculation is provided.

WO 2020/127668 describes a roasting apparatus wherein the roasting parameters can be adapted for a customized quantity of beans introduced inside the apparatus. The control system is configured to get access to a series of several pre-determined roasting recipes (Rᵢ, Rᵢ₊₁, . . . ) adapted to the roasting of different successive pre-determined quantities (Mᵢ, Mᵢ₊₁, . . . ) of beans of same type and to said pre-determined quantities Mᵢ, Mᵢ₊₁, . . . . This apparatus provides optimal roasting whatever the quantity of beans to roast. Yet it is necessary to have access to a series of pre-determined roasting recipes, meaning pre-determination of several roasting recipes requiring a certain work to pre-determine these recipes.

WO 2020/127673 describes a roasting apparatus wherein the roasting parameters can be adapted for a customized quantity m of beans introduced inside the apparatus. The control system is configured to get access at least one pre-determined roasting recipe providing the temperature T_{@t1}, T_{@t2}, . . . to be applied at discrete successive times t₁, t₂, . . . for a pre-determined quantity M of beans and to calculate the new roasting recipe for a customised quantity m by applying specific formulas to the temperatures T_{@ti of the} pre-determined roasting recipe and taking into account the customized quantity m and the pre-determined quantity M.

This method of determining the roasting recipe of a customized quantity of beans from one pre-determined roasting recipe only can be improved, in particular by providing more consistency in the roasting of beans of the same type whatever the roasted quantity.

### SUMMARY OF THE INVENTION

An object of the present invention is to improve the automatic roasting of coffee beans.

It would be advantageous to provide a roasting apparatus enabling optimal and consistent roasting whatever the quantity of beans to roast.

It would be advantageous to provide a roasting apparatus applying automatically the roasting profile corresponding to the quantity of beans introduced in the apparatus.

Objects of the invention are achieved by the method for roasting coffee beans according to claim 1, the apparatus according to claim 16, the system of roasting apparatuses according to claim 19 and the computer programs according to claims 20 and 21.

In a first aspect of the invention, there is provided a method to determine the recipe R_{ym} for roasting a quantity m of a type C_{y} of coffee beans in a particular type of roasting apparatus, said recipe R_{ym} providing setpoints (T_{ym@ti}; ti) of temperatures T_{ym@ti}, T_{ym@t2}, . . . to be applied at discrete successive times t₁, t₂, . . . , respectively,

wherein the method comprises the steps of:
getting access:
   to a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and
   to the list of the pre-determined quantities (M, M±Δx), and
   to at least one pre-determined original roasting recipe R_{yMoriginal}, said roasting recipe R_{yMoriginal} being adapted to the roasting of one original pre-determined quantity Moriginal of beans of type C_{y} in said particular type of roasting apparatus, said pre-determined original roasting recipe R_{yMoriginal} providing setpoints (T_{yMonginal@ti}; ti) of temperatures T_{yMonginal@ti}, T_{yMonginal@t2}, . . . to be applied at discrete successive times t₁, t₂, respectively, and
   to said original pre-determined quantity Moriginal of beans, and
based on:
   the comparison between m and the accessible original pre-determined quantity Moriginal and on the comparison between m and the accessible pre-determined quantities of the list (M, M±Δx) and
   the comparison between Moriginal and the accessible pre-determined quantities of the list (M, M±Δx)

determining the roasting recipe R_{ym} to be applied on said quantity m of coffee beans as follows:
if m is equal to the accessible original pre-determined quantity Moriginal, then the roasting recipe R_{ym} corresponds to the accessible pre-determined original roasting recipe R_{yMoriginal},
if m is different from the accessible original pre-determined quantity Moriginal, and
   if the accessible original pre-determined quantity Moriginal is equal to one of the accessible pre-determined quantities of the list (M, M±Δx), and
   if m is equal to one of the other accessible pre-determined quantities (M, M±Δx) of the list, then the roasting recipe R_{ym} is calculated by applying the rule to the accessible pre-determined original roasting recipe R_{yMoriginal},
   if m is different from the accessible pre-determined quantities (M, M±Δx) of the list, then the roasting recipe R_{ym} is deduced from the accessible pre-determined original roasting recipe R_{yMoriginal}, and/or at least one of the roasting recipes R_{yM}, R_{yM±Δx} able to be calculated by applying the rule to the accessible pre-determined roasting recipe R_{yMoriginal}.
   if Moriginal is different from any of the accessible pre-determined quantities of the list (M, M±Δx), then identifying, in said list, the quantity M_{closest} presenting the smallest difference with Moriginal and deducing the corresponding roasting recipe R_{yMclosest} from the accessible pre-determined roasting recipe R_{yMoriginal}, and then:
   if m is equal to said quantity M_{closest} presenting the smallest difference with Moriginal, then the roasting recipe R_{ym} corresponds to deduced roasting recipe R_{yMclosest},
   if m is different from M_{closest} but equal to one of the other accessible pre-determined quantities (M, M±Δx) of the list, then the roasting recipe R_{ym} is calculated by applying the rule to the deduced roasting recipe R_{yMclosest},
   if m is different from any of the accessible pre-determined quantities (M, M±Δx) of the list, then the roasting recipe R_{ym} is deduced from the accessible original roasting recipe R_{yMoriginal}, and/or at least one of the roasting recipes R_{yM}, R_{yM±Δx} able to be calculated by applying the rule to the deduced roasting recipe R_{yMclosest}.

This method relates to the determination of the recipe for roasting a customised quantity m of coffee beans of a specific type C_{y} with a particular type of roasting apparatus based on:
the existence of one pre-determined original roasting recipe R_{yMoriginal} adapted to the roasting of one pre-determined quantity Moriginal of beans of type C_{y} in said particular type of roasting apparatus, and
on a pre-determined rule of calculation providing a relationship between the roasting recipes adapted to the roasting of specific quantities of beans and comprised in a list of pre-determined quantities (M, M±Δx) and
on the comparison between the new customised quantity m, the pre-determined quantity Moriginal and the pre-determined quantities (M, M±Δx).

Accordingly, based on the existence of only one pre-determined roasting recipe adapted to one quantity of beans, the roasting recipe of any customised quantity of beans can be automatically calculated as developed below.

The pre-determined original roasting recipe R_{yMoriginal} provides setpoints (T_{yMonginal@ti}; ti) of temperatures T_{yMonginal@ti}, T_{yMonginal@t2}, . . . to be applied at discrete successive times t₁, t₂, . . . , respectively.

Usually these pre-determined original roasting recipe R_{yMoriginal} is defined by a coffee expert by roasting beans C_{y} in a master roasting apparatus. This master roasting apparatus is used to define the original recipes for all coffees C_{y}.

Then the present method enables the determination of a new roasting recipe for any new quantity of beans roasted in a roasting apparatus that is of the same type as the master roasting apparatus. This new recipe guarantees the obtention of the same final roasted beans (colour, aroma, density, . . . ) as for the roasting of the pre-determined quantity Moriginal of beans according to the pre-determined original roasting recipe R_{yMoriginal}. Consequently, consistent roasting is obtained for the different quantities of the same type of beans to be roasted.

The accessible original roasting recipe R_{yMoriginal} is adapted for a specific type C_{y} of coffee beans and for a pre-determined quantity Moriginal of said beans and for a specific type of roasting apparatus. Accordingly, for one type of beans, at least one original roasting recipe adapted to the roasting of said pre-determined quantity Moriginal is accessible. Usually, this original roasting recipe was established by a coffee roasting expert and provides the exact setpoints measured during a roasting operation for optimally roasting the quantity M of coffee beans of type C_{y}.

Preferably, the method requires the access to the pre-determined quantity Moriginal associated to the roasting recipe R_{yMoriginal} too. In one embodiment, this pre-determined quantity can be the same for all the accessible original roasting recipes R_{yMoriginal} and this pre-determined quantity can be set by default.

In another embodiment, this pre-determined quantity can be different according to the coffee beans C_{y} and its roasting recipe R_{yMoriginal}. In that latter case, the method requires the access to said pre-determined quantity Moriginal associated to the respective roasting recipe R_{yMoriginal}.

In some embodiments of the method, for a specific type C_{y} of coffee beans, access to several original roasting recipes R_{yzMoriginal} is possible, these original roasting recipes differing by other characteristics than the type C_{y} or the quantity M_{onginal}, in particular these original recipes differing by the final level of roasting (low, medium, dark) to be applied to the beans and/or the further use of the roasted beans as explained below.

As mentioned above, this roasting recipe R_{yMonginal} adapted to the roasting of the pre-determined quantity M_{onginal} of one type of beans is defined by experimentation: it reflects the sensory taste that the roasting expert targets for the customers who will drink coffee extracted from this type of roasted beans. The roasting recipe is linked also to one type of roasting apparatus itself because roasting profiles can vary depending on the type of type of agitation of the beans (fluidic bed or rotating drum), the internal design like the shape of the chamber, the position of the key components (e.g. the temperature sensor) and/or the type of control system operable to control the heating device.

In addition, the method requires access to:
to a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and
to the list of said pre-determined quantities (M, M±Δx). This rule is applicable whatever the specific type of beans that are going to be roasted. This rule provides a correspondence between one pre-existing roasting recipe adapted for one quantity of the list, for example R_{M} adapted for the quantity M, and all the roasting recipes R_{M±Δx} adapted for the other quantities of the list either higher (M+Δx) or smaller (M−Δx) and differing by a quantity Δx (Δ₁, Δ₂, Δ₃, . . . ). Consequently, based on the knowledge of the rule and one pre-existing roasting recipe for one quantity of the list, all the roasting recipes adapted for the other quantities can be calculated automatically.

Since it has been observed that with a particular type of apparatus, the rule is the same for different types of beans, when it is desired to roast a new type of beans with this particular apparatus, it is not necessary any longer to determine roasting recipes for different quantities of said beans. The determination of one pre-existing roasting recipe for one quantity of the list is sufficient to deduce the roasting recipes for other quantities.

In a particular mode the rule can be specific to one particular family of beans in particular a botanical type like Robusta or Arabica beans.

This rule is usually defined by experimentation. The rule is linked to the particular type of roasting apparatus.

Preferably, the pre-determined quantities of the list M and M±Δx defined in the rule can correspond to quantities ranging between the higher and smaller quantities that can be roasted in the vessel of the roasting apparatus in which the rule was defined.

Preferably at least two quantities are pre-determined: one higher than M and the other lower than M; usually these at least two upper and lower pre-determined quantities present the same difference of quantity (Δ1) with M.

Preferably, the pre-determined quantity M can correspond to the quantity that is optimal for the roasting in the volume of the vessel of the apparatus. Then the pre-determined quantities M+Δ1, M+Δ2, . . . and M−Δ1, M−Δ2, . . . can correspond to quantities ranging between the higher and smaller quantities that can be roasted in the vessel of the roasting apparatus, as mentioned above.

Alternatively but less preferably, the pre-determined quantity M can correspond to the minimum quantity of beans that can be roasted in the volume of the vessel of the apparatus and the at least one pre-determined quantity M+Δ1 can correspond to the maximum quantity that can be roasted in the vessel of the roasting apparatus.

The manner to determine the roasting recipe R_{ym} to be applied on the customised quantity m of coffee beans of type C_{y} depends on:
the comparison between m and the accessible original pre-determined quantity M_{onginal}, and
the comparison between M_{onginal} and the accessible pre-determined quantities of the list (M, M±Δx), and
the comparison between m and the accessible pre-determined quantities of the list (M, M±Δx).

If m is equal to the accessible original pre-determined quantity M_{onginal}, this is the simplest manner to determine the roasting recipe R_{ym}, since in that case, R_{ym} corresponds to the accessible original roasting recipe R_{yMonginal}.

If m is different from the accessible original pre-determined quantity M_{onginal}, then the method to determine the roasting recipe R_{ym} depends on the comparison between M_{onginal} and the accessible pre-determined quantities of the list (M, M±Δx), that is depends if the pre-determined original roasting recipe R_{yMonginal}, is adapted to the roasting of a quantity of beans that is comprised in the list of pre-determined quantities (M, M±Δx) of the rule.

If one first case, the accessible original pre-determined quantity Moriginal is equal to one of the accessible pre-determined quantities of the list (M, M±Δx), and
if m is equal to one of the other accessible pre-determined quantities (M, M±Δx) of the list, then the roasting recipe R_{ym} can be calculated by applying the rule to the accessible pre-determined original roasting recipe R_{yMoriginal}, or
if m is different from the accessible pre-determined quantities (M, M±Δx) of the list, then the roasting recipe R_{ym} is deduced from the accessible original roasting recipe R_{yMoriginal}, and/or at least one of the roasting recipes R_{yM}, R_{yM±Δx} that can be calculated by applying the rule to the accessible roasting recipe R_{yMoriginal}.

If one second case, the accessible original pre-determined quantity Moriginal is different from any of the accessible pre-determined quantities of the list (M, M±Δx). Then, the manner to determine the roasting recipe comprises:
identifying, in said list, the quantity M_{closest} presenting the smallest difference with Moriginal and deducing the corresponding roasting recipe R_{yMclosest} from the accessible roasting recipe R_{yMoriginal}. Then:
   if m is equal to said quantity M_{closest} presenting the smallest difference with Moriginal, then the roasting recipe R_{ym} corresponds to said deduced roasting recipe R_{yMclosest},
   if m is different from M_{closest} but equal to one of the other accessible pre-determined quantities (M, M±Δx) of the list, then the roasting recipe R_{ym} is calculated by applying the rule to the deduced roasting recipe R_{yMclosest},
   if m is different from any of the accessible pre-determined quantities (M, M±Δx) of the list, then the roasting recipe R_{ym} is deduced from the accessible original roasting recipe R_{yMoriginal}, and/or at least one of the roasting recipes R_{yM}, R_{yM±Δx} able to be calculated by applying the rule to the deduced roasting recipe R_{yMclosest}.

This rule and this method enable the customisation of the quantity of beans roasted by the operator while guaranteeing the obtention of the same final roasted beans whatever the roasted quantity. Roasting is consistent whatever the roasted quantity.

The rule avoids the storage of numerous roasting recipes for different types C_{y} of beans and for different quantities of said different beans. Only one single original roasting recipe R_{yMoriginal} for one type of beans and one quantity of said beans needs to be accessible. Then, based on the rule, the roasting recipe for any quantity of said beans can be calculated or deduced or approached.

In general, this rule is a mathematical function, such as a polynomial (e.g. linear or quadratic), logarithmic or exponential function, applied to the temperatures T_{@ti} of the setpoints of the pre-existing roasting recipe adapted to the roasting of another quantity of beans comprised in the list of pre-determined quantities (M, M±Δx).

The mathematical function provides correspondence between all the roasting recipes adapted to the roasting of a quantity of beans comprised in the list of pre-determined quantities (M, M±Δx). Accordingly, by having access to one pre-existing roasting recipe adapted to one of said quantities, then all the other roasting recipes adapted to the other quantities can be calculated.

In the preferred embodiment, the rule to calculate from one pre-determined original roasting recipe R_{yM} (T_{yM@ti}; ti) at least one roasting recipe R_{yM±Δx} (T_{yM±Δx @ti}; ti) adapted to the roasting of a pre-determined quantity M±Δx of beans is a linear function and this rule is defined by at least one couple of pre-determined coefficients (a_{(M;M±Δx)}; b_{(M;M±Δx)}), said coefficients being specific to the difference of quantity ±Δx between M and M±Δx, and the rule is applicable to the temperatures T_{yM@ti} provided by the pre-determined original roasting recipe R_{M} as follows:

T_{yM±Δx@}ti=a_{(M;M±Δx)}T_{yM@ti}+b_{(M;M±Δx)}

In a particular embodiment of the method, said polynomial rule is defined by at least two couples of pre-determined coefficients (a_{(M;M±Δx)}; b_{(M;M±Δx)}), each of said couple being applied during a specific range of time Δti of the pre-determined roasting recipe R_{yM}.

In particular, one range of time Δti₁ can correspond to the first phase of drying the beans and another range of time Δti₂ can correspond to the two following phases of the roasting operation that is the phases during which Maillard reactions occur and then development (also called finishing) follows.

For the first phase of drying the beans, a first couple of pre-determined coefficients can be defined whatever the quantity of beans, whereas for the following phases, it is preferred to use other couples of pre-determined coefficients that are specific to the quantities of beans in order to adapt energy applied to the quantity of beans in these critical phases.

In one mode, during different specific ranges of time Δti at least one of the coefficient of the couple (a_{(M;M±Δx)}; b_{(M;M±Δx)}) can be defined as a function of time which varies with time along the range of time Δti during the reproduction of roasting recipes.

Alternatively, during a specific range of time Δti at least one of the coefficient of the couple (a_{(M;M±Δx)}; b_{(M;M±Δx)}) can be constant. The constant can be different for different ranges of time Δti.

In one embodiment, for one particular type of roasting apparatus, different rules can be defined for different families of beans. Accordingly, for each family corresponds a specific rule to calculate from one pre-determined original roasting recipe R_{M} at least one roasting recipe R_{M±Δx} adapted to the roasting of a pre-determined quantity M±Δx of beans. Based on the obtained type C_{y}, the control system is configured to get access directly to the rule configured to the type C_{y} of beans or alternatively to the family to which this type C_{y} belongs and then to the rule corresponding to said family.

It is possible to group coffees beans in families that react in a similar way when they are roasted. In one same family, the beans are roasted globally according to similar roasting profiles. In one family, different types of beans present different roasting profiles but the same rule can be applied to all the types of beans of said family due to their similarities.

In one embodiment, the family can be linked to the botanical variety of the beans (for example, Arabica and Robusta can form two different families with different specific rules).

According to the preferred embodiment of the method, the accessible original pre-determined quantity M_{onginal} is equal to one of the accessible pre-determined quantities of the list (M, M±Δx) of the rule.

Actually, usually, it is preferred to provide access to pre-determined original roasting recipes that were established for these pre-determined quantities of the rule to avoid too many long calculations or approximations during the determination of the roasting recipe for the customised quantity m.

According to said above preferred embodiment of the method, if m is different from M and from any of the accessible quantities M±Δx, then the roasting recipe R_{ym} to be applied on said obtained quantity m of coffee beans introduced inside the vessel can be deduced from one or two of the accessible roasting recipe R_{yM} and/or the calculable roasting recipes R_{yM±Δx}, each of said one or two recipes being adapted to the roasting of one pre-determined quantity of beans respectively and said pre-determined quantity or quantities of beans presenting the smallest difference(s) of quantity with the obtained quantity m.

In one first mode of this preferred embodiment, the roasting recipe R_{ym} to be applied on said obtained quantity m of coffee beans introduced inside the vessel can be deduced by selecting in the list of the accessible roasting recipe R_{yM} and/or the calculable roasting recipes R_{yM±Δx}, the roasting recipe adapted to the roasting of one pre-determined quantity of beans presenting the smallest difference of quantity with the obtained quantity m.

In that first mode, the roasting recipe R_{ym} is this selected accessible roasting recipe R_{yM} or calculable roasting recipes R_{yM}±Δx.

In one second mode of this preferred embodiment, the roasting recipe R_{ym} to be applied on said obtained quantity m of coffee beans introduced inside the vessel can be deduced by:
identifying in the list of the accessible pre-determined quantities M and M±Δx, the two successive pre-determined quantities Mₘ₋₁ and Mₘ₊₁ presenting the smallest differences with m, wherein Mₘ₋₁ is inferior to Mₘ₊₁,
for said two identified quantities Mₘ₋₁ and Mₘ₊₁ obtaining the corresponding roasting recipe R_{Mm-1} and R_{Mm+1} respectively, said recipes being determined as follows:
   if one of the identified quantities Mₘ₋₁ or Mₘ₊₁ is equal to the pre-determined quantity M, then getting access to the pre-determined original roasting recipe R_{yM} adapted to the roasting of said pre-determined quantity M of beans,
   if one or two of said identified quantities Mₘ₋₁ and/or Mₘ₊₁ differ(s) from the pre-determined quantity M, then calculating the corresponding roasting recipes R_{Mm-1} and/or R_{Mm+1} by applying the rule to the accessible roasting recipe R_{yM},
from the obtained roasting recipes R_{Mm-1} and R_{Mm+1}, said recipes providing the temperatures T_{Mm-1@t1}, T_{Mm-1@t2}, . . . and T_{Mm+1@t1}, T_{Mm+1@t2}, . . . respectively applied at discrete successive times t₁, t₂, . . . , determining the temperature T_{m@t1}, T_{m@t2}, . . . to be applied to the obtained quantity m of beans at each of said discrete successive times t₁, t₂, . . . as follows:

T_{m@t1}=T_{Mm-1@ti}+[(T_{Mm+1@ti}−T_{Mm-1@ti})·K·(m−Mₘ₋₁)/(Mₘ₊₁−Mₘ₋₁)]

with K≤1.

In this second mode, the roasting recipe R_{ym} is deduced from the accessible roasting recipe R_{yM} and/or at least one of the roasting recipe R_{yM±Δx} calculated by applying the rule to the accessible roasting recipe R_{yM}.

This second mode provides a more accurate determination of the roasting recipe to be applied on said quantity m of coffee beans compared to the first mode since a specific roasting profile is determined for each specific quantity.

K can be pre-determined and accessible during the method. By default, K equals 1.

In one third mode of this preferred embodiment of the method, the roasting recipe R_{ym} to be applied on said obtained quantity m of coffee beans introduced inside the vessel is deduced by.
identifying in the list of the accessible pre-determined quantities M and M±Δx, the two successive pre-determined quantities Mₘ₋₁ and Mₘ₊₁ presenting the smallest differences with m,
for said two identified quantities Mₘ₋₁ and Mₘ₊₁ obtaining the corresponding roasting recipe R_{Mm-1} and R_{Mm+1} respectively, said recipes being determined as follows:
   if one the identified quantities Mₘ₋₁ or Mₘ₊₁ is equal to the pre-determined quantity M, then getting access to the pre-determined original roasting recipe R_{yM} adapted to the roasting of said pre-determined quantity M of beans,
   if one or two of said identified quantities Mₘ₋₁ and/or Mₘ₊₁ differ(s) from the pre-determined quantity M, then calculating the corresponding roasting recipes R_{Mm-1} and/or R_{Mm+1} by applying the rule to the accessible roasting recipe R_{yM},
from the obtained roasting recipes R_{Mm-1} and R_{Mm+1}, said recipes providing the temperatures T_{Mm-1@t1}, T_{Mm-1@t2}, . . . and T_{Mm+1@t1}, T_{Mm+1@t2}, . . . respectively applied at discrete successive times t₁, t₂, . . . , determining the temperature T_{m@t1}, T_{m@t2}, . . . to be applied to the obtained quantity m of beans at each of said discrete successive times ti₁ t₂, . . . as follows:
if m is closer to Mₘ₋₁, then:

T_{m@t1}=T_{Mm-1@ti}+[(T_{Mm+1@ti}−T_{Mm-1∜ti})·K·(m−Mₘ₋₁)/(Mₘ₊₁−Mₘ₋₁)]
if m is closer to Mₘ₊₁, then:

T_{m@t1}=T_{Mm-1@ti}−[(T_{Mm+1@ti}−T_{Mm-1∜ti})·K·(Mₘ₊₁−m)/(Mₘ₊₁−Mₘ₋₁)]

with K≤1.

This third mode provides a more accurate determination of the roasting recipe to be applied on said quantity m of coffee beans compared to the second mode.

K can be pre-determined and accessible during the method. By default, K equals 1.

In the second and third modes of this particular embodiment, the method can comprise the steps of:
based on the type C_{y} of coffee beans, getting access to a coefficient K_{y} specific to said type C_{y} of coffee beans, and
deducing the roasting recipe R_{ym} by using K_{y} as coefficient K.

In an alternative to this embodiment, if the rule is a linear function and couples of pre-determined coefficients (a_{(M;M±Δx)}; b_{(M;M±Δx)}) are accessible, then the method to determine the recipe R_{ym} can be deduced by:
identifying in the list of the accessible pre-determined quantities M and M±Δx, the two successive pre-determined quantities Mₘ₋₁ and Mₘ₊₁ presenting the smallest differences with m, wherein Mₘ₋₁ is inferior to Mₘ₊₁,
for said two identified quantities Mₘ₋₁ and Mₘ₊₁, obtaining the corresponding at least one couple of pre-determined coefficients (a_{(M;Mm-1)};b_{(M;Mm-1)}) and (a_{(M;Mm+1)};b_{(M;Mm+1)}), wherein if one of said two identified quantities Mₘ₋₁ and Mₘ₊₁ is equal to M, then the corresponding couple of pre-determined coefficients is (1;1),
from said obtained couples of pre-determined coefficients (a_{(M;Mm-1)};b_{(M;Mm-1)}) and (a_{(M;Mm+1)};b_{(M;Mm+1)}), determining at least one couple of coefficients a_{(M;m)} as follows:

a_{(M;m)}=a_{(M;Mm-1)}+[(a_{(M;Mm+1)}−a_{(M;Mm-1)})·K·(m−Mₘ₋₁)(Mₘ₊₁−Mₘ₋₁)]

with K≤1,
from said determined at least one couple of coefficients a_{(M;m)} and from the pre-determined original roasting recipe R_{yM} (T_{yM@ti}; ti), calculating the roasting recipe R_{ym} providing the temperature T_{m@t1}, T_{m@t2}, . . . to be applied to the obtained quantity m of beans at each of said discrete successive times t₁, t₂, . . . as follows:

T_{ym@ti}=a_{(M;m)}T_{yM@ti}+b(M;m).

The coefficient K is the same as mentioned above.

In one particular embodiment, the method can enable the determination of an additional roasting recipe R_{flow-ym} for roasting a quantity m of a type C_{y} coffee beans in a specific roasting apparatus comprising an air flow driver, wherein said method enables the determination of an additional roasting recipe R_{flow-ym} for roasting a quantity m of a type C_{y} coffee beans in a roasting apparatus said additional roasting recipe providing setpoints (F_{ym@ti}; ti) of an air flow F_{@t1}, F_{@t2}, . . . to be applied at discrete successive times t₁, t₂, . . . ,

wherein the method comprises the steps of:
getting access:
   to a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and
   to the list of the pre-determined quantities (M, M±Δx), and
   to at least one pre-determined original roasting recipe R_{flow-yMoriginal}, said roasting recipe R_{flow-yMoriginal} being adapted to the roasting of one original pre-determined quantity M_{original} of beans of type C_{y} in said particular type of roasting apparatus, and
   to said original pre-determined quantity M_{original} of beans, and
based on:
   the comparison between m and the accessible original pre-determined quantity M_{original} and on the comparison between m and the accessible pre-determined quantities of the list (M, M±Δx) and
   the comparison between M_{original} and the accessible pre-determined quantities of the list (M, M±Δx)

determining the roasting recipe R_{flow-ym} to be applied on said quantity m of coffee beans as follows:
if m is equal to the accessible original pre-determined quantity M_{original}, then the roasting recipe R_{flow ym} corresponds to the accessible original roasting recipe R_{flow-yMoriginal},
if m is different from the accessible original pre-determined quantity M_{original}, and if the accessible original pre-determined quantity M_{original} is equal to one of the accessible pre-determined quantities of the list (M, M±Δx), and
if m is equal to one of the other accessible pre-determined quantities (M, M±Δx) of the list, then the roasting recipe R_{flow ym} is calculated by applying the rule to the accessible pre-determined original roasting recipe R_{flow-yMoriginal},
if m is different from the accessible pre-determined quantities (M, M±Δx) of the list, then the roasting recipe R_{flow-ym} is deduced from the accessible original roasting recipe R_{flow-yMoriginal}, and/or at least one of the roasting recipes R_{flow-yM}, R_{flow yM±Δx} able to be calculated by applying the rule to the accessible roasting recipe R_{flow-yMoriginal}.
if M_{original} is different from any of the accessible pre-determined quantities of the list (M, M±Δx), then identifying, in said list, the quantity M_{closest} presenting the smallest difference with M_{original} and deducing the corresponding roasting recipe R_{flow-yMclosest} from the accessible roasting recipe R_{flow-yMonginal}, and then:
if m is equal to said quantity M_{closest} presenting the smallest difference with M_{original}, then the roasting recipe R_{flow-ym} corresponds to deduced roasting recipe R_{flow-yMclosest},
if m is different from M_{closest} but equal to one of the other accessible pre-determined quantities (M, M±Δx) of the list, then the roasting recipe R_{flow-ym} is calculated by applying the rule to the deduced roasting recipe R_{flow-yMclosest}
if m is different from any of the accessible pre-determined quantities (M, M±Δx) of the list, then the roasting recipe R_{flow-ym} is deduced from the accessible original roasting recipe R_{flow-yMoriginal}, and/or at least one of the roasting recipes R_{flow-yM}, R_{flow-ym±Δx} able to be calculated by applying the rule to the deduced roasting recipe R_{flow-yMclosest}.

Preferably, the rule to calculate from one pre-determined roasting recipe R_{flow-yM} (F_{yM@t1}, tᵢ) adapted to the roasting of a pre-determined quantity M of beans at least one roasting recipe R_{flow-ym±Δx} (F_{yM±Δx}@ti; ti) adapted to the roasting of a pre-determined quantity M±Δx of beans is a polymial function,

said rule being defined by a couple of pre-determined coefficients (c_{(M;M±Δx)}; d_{(M;M±Δx)}) and being applied to the air flow provided by the pre-determined roasting recipe R_{fnlow-M} as follows:

F_{yM±Δx@ti}=C_{(M;M±Δx)}F_{yM@t}_{ᵢ}+d_{(M;M±Δx)}

If, in addition, the rule to calculate from one pre-existing roasting recipe R_{M} (T_{M@ti}, tᵢ) adapted to the roasting of a pre-determined quantity M of beans at least one roasting recipe R_{M±Δx} (T_{M±Δx@}ti; ti) adapted to the roasting of a pre-determined quantity M±Δx of beans is a linear function,

said rule being defined by at least one couple of pre-determined coefficients (a_{(M;M±Δx)}; b_{(M;M±Δx)}), said coefficients being specific to the difference of quantity ±Δx, and said rule being applied to the temperatures T_{yM@ti} provided by the pre-determined original roasting recipe R_{M} as follows:

T_{yM±Δx@}ti=a_{(M;M±Δx)}T_{yM@ti}+b_{(M;M±Δx)}.

then, the method can comprise getting access to a ratio R and the couple of pre-determined coefficients (c_{(M;M±Δx)}; d_{(M;M±Δx)}) can be defined as follows:

C_{(M;M±Δx)}=Ra_{(M;M±Δx)}, and

d_{(M;M±Δx)}=Rb_{(M;M±Δx)}

Preferably the ratio R can be pre-set according to the type coffee beans.

Preferably in the above method, the quantities are weight.

In a second aspect of the invention, there is provided a method to determine the recipe R_{blend} for roasting a customised blend of coffee beans C_{A}, C_{B}, . . . with respective quantities M_{A}, m_{B}, . . . of said coffee beans in a particular type of roasting apparatus, said recipe R_{blend} providing setpoints (T_{blend@ti}; ti) of temperatures T_{blend@ti}, T_{blend@t2}, . . . to be applied at discrete successive times t₁, t₂, . . . , respectively, wherein the method comprises the steps of:
for each type of coffee beans C_{y} part of the blend, determining the roasting recipe R_{ym} to be applied on said quantity my of coffee beans according to the method described above,
getting access to temperature adaptation factors X_{y} of said different types of coffee beans C_{y} respectively of the customised blend,
from said determined roasting recipes R_{ym} and from said accessible temperature adaptation factors X_{y}, and based on the quantities my of beans of type C_{y}, determining the temperature T_{blend@t1}, T_{blend@t2}, . . . , to be applied to the customised blend of beans at each of discrete successive times t₁, t₂, . . . respectively according to following formula (I):

$${T}_{blend @ {t}_{i}} = {\sum }_{y} {f}_{y} \cdot {X}_{y} \cdot {T}_{{m}_{y} @ {t}_{i}} \qquad ( I )$$

wherein y corresponds to all the types of coffee beans present in the blend and f_{y} represents the fraction in weight of coffee beans of type C_{y} in the blend of coffee beans.

The determination of the roasting recipes adapted to the roasting of the specific coffee beans part of the blend and for the specific quantity of said beans part of the blend provides a good starting point to calculate the roasting recipe of the blend.

In addition, the formula (I) uses these selected roasting recipes with a quantity factor f_{y} which is able to take into account the presence of a greater part of one type of beans C_{y} inside the blend.

In addition the formula (I) uses these selected roasting recipes with a temperature adaptation factor X_{y} which enables to provide more or less importance to the roasting profile of one of the type of beans in the roasting profile of the blend. This factor takes into account, among other aspects, the capacity of the respective beans C_{y} to absorb heat, which can vary with the size of this bean, its density, its internal structure and/or its chemical composition. For example two types of beans can differ by their sizes, as a result, less heat energy is required for the smaller. This factor can take into account a particular desired property of these beans once roasted in the blend, this desired property can relate to the colour of the roasted beans, its level of acrylamide and/or its sensory profile in the final roasted blend.

Actually, due to the fact that the blend comprises different types of beans presenting different reactions further to the implementation of a common roasting profile, the final roasted blend may comprise roasted beans presenting different colours and/or different levels of specific components like acrylamide or furan generated by roasting and/or different optimal sensory profile. In order to control the production of roasted blends presenting all or some of these properties, temperature adaptation factor are used to keep specific coffee beans, in particular the more sensitive, closer to their respective roasting profile in order to obtain the desired properties of these beans.

For different beans, the key criteria for defining the temperature adaptation factor can be different since some beans may be more or less sensitive to deviation from their optimal roasting profile.

Usually, when a blend is created, it is expected to produce a resulting roasted blend presenting properties corresponding globally to an average of the properties of each types of beans roasted separately in particular the best properties of each of these beans. The temperature adaptation factor guarantees that the properties of the beans that are the more sensitive to temperature will be found in the roasted blend.

The value of the temperature adaptation factor X_{y} is usually comprised between 0.5 and 2. Factors with low value are adapted to beans being less sensitive to temperature variation whereas factors with high value are adapted to more reactive beans that develop new properties if roasted at temperatures too much different from their optimal roasting profile. These factors are usually defined by experimentation.

The formula enables the automatic calculation of the roasting recipe of the blend. A non-experimented operator becomes able to roast a blend of different types of coffee without risk that the resulting roasted blend presents a poor taste profile, in particular is burnt or not roasted enough. The risk the beans are wasted is prevented.

According to a third aspect, there is provided an alternative method to determine the recipe R_{blend} for roasting a customised blend of coffee beans of different types C_{y} with respective quantities my of said coffee beans in a particular type of roasting apparatus, said recipe R_{blend} providing setpoints (T_{blend@ti}; ti) of temperatures T_{blend@ti}, T_{blend@t2}, . . . to be applied at discrete successive times t₁, t₂, . . . , respectively, wherein the method comprises the steps of:
getting access:
   for each types of coffee beans C_{y} comprised in the blend, to at least one pre-determined original roasting recipes R_{yMoriginal} respectively, each recipe R_{yMoriginal} (T_{yMoriginal}_{_{@ti}}; tᵢ) being adapted to the roasting of one original pre-determined quantity M_{original} of beans of type C_{y} in said particular type of roasting apparatus,
   to said original pre-determined quantity M_{original} of beans, and
   to a rule to calculate from one pre-determined original roasting recipe R_{yMoriginal} (T_{yMoriginal@ti}; tᵢ) at least one roasting recipe R_{Moriginal±Δx} adapted to the roasting of a pre-determined quantity M_{original±Δx} of beans in said particular type of roasting apparatus, said rule being a linear function, and said being defined by at least one couple of pre-determined coefficients (a_{(Moriginal,Moriginal±Δx)}; b_{(Moriginal; Moriginal±Δx)}), said coefficients being specific to the difference of quantity ±Δx, and said rule being applied to the temperatures T_{Moriginal}_{_{@}}ₜᵢ provided by one pre-determined original roasting recipe R_{Moriginal} as follows:

T_{Moriginal±Δx@}ti=a_{(Moriginal;Moriginal±Δx)}T_{Moriginal@ti}+b_{(Moriginal;Moriginal±Δx)}.
and
to said at least one pre-determined quantity M_{original}±Δx, and
to temperature adaptation factors X_{y} of said different types of coffee beans C_{y} respectively, and
for each type of coffee beans C_{y} part of the blend, identifying in the list of pre-determined quantities M_{original} and M_{original±Δx} the quantity M_{closest} presenting the smallest difference with my and deducing the corresponding couple of coefficients (a_{y}:b_{y}) as follows:

a_{y}=a_{(Moriginal;Mclosest)};

b_{y}=b_{(Moriginal;Mclosest)},
calculating the corresponding couple of coefficients of the blend as follows:

$${a}_{b l e n d} = {\sum }_{y} {f}_{y} \cdot {a}_{y}$$

$${b}_{blend} = {\sum }_{y} {f}_{y} \cdot {b}_{y}$$

wherein y corresponds to all the types of coffee beans present in the blend and f_{y} represents the fraction in weight of coffee beans of type C_{y} in the blend of coffee beans,
determining the temperature T_{blend@ti}, T_{blend@t2}, . . . , to be applied to the customised blend of beans at each of discrete successive times t₁, t₂, . . . respectively according to following formula (II):

$${T}_{blend @ {t}_{i}} = {a}_{blend} ( {\sum }_{y} {f}_{y} \cdot {X}_{y} \cdot {T}_{yMoriginal @ ti} ) + {b}_{blend} \qquad ( II )$$

wherein y corresponds to all the types of coffee beans present in the blend and f_{y} represents the fraction in weight of coffee beans of type C_{y} in the blend of coffee beans.

In this method, for all types of coffee beans C_{y} comprised in the blend, the corresponding pre-determined original roasting recipe R_{yMonginal} is adapted to the roasting of the original pre-determined quantity M_{original} of beans in said particular type of roasting apparatus,

In a fourth aspect of the invention, there is provided an apparatus for roasting coffee beans comprising:
a vessel to contain coffee beans,
a heating device to heat coffee beans contained in the vessel,
a control system operable to control the heating device and configured to apply a roasting recipe (R) providing setpoints (T_{@ti}; ti) of temperatures T_{@t1}, T_{@t2}, . . . to be applied at discrete successive times t₁, t₂, . . . , respectively,

wherein, for a customised quantity m of coffee beans of type C_{y} introduced inside the vessel,
the control system is configured to obtain at least:
   the quantity m of coffee beans introduced inside the vessel, and
   the type C_{y} of coffee beans introduced inside the vessel,

and
based on the obtained type C_{y} and the obtained quantity m, the control system is configured to determine the recipe R_{ym} for roasting the quantity m of coffee beans of type C_{y} in the roasting apparatus according to the method described above.

The roasting apparatus comprises a vessel to contain coffee beans during the roasting process. In the vessel coffee beans are heated and preferably mixed to homogenise heating through the beans.

Mixing can be obtained with a fluidic bed of hot air or mechanically with stirring blades or through rotation of a rotating drum.

Preferably the vessel is hot air fluid bed chamber. Within such a vessel, heated air is forced through a screen or a perforated plate under the coffee beans with sufficient force to lift the beans. Heat is transferred to the beans as they tumble and circulate within this fluidized bed.

Alternatively the vessel can be a drum chamber wherein the coffee beans are tumbled in a heated environment. The drum chamber can consist of a horizontal rotating drum or the drum chamber can comprise stirring blades to tumble the coffee beans in a heated environment.

The roasting apparatus comprises a device to heat coffee beans contained in the vessel. Preferably, the heating device is configured to produce a flow of hot air, said flow of hot air being directed to the coffee beans contained in the vessel in order to heat them. Usually, the heating device comprises at least an air driver or a fan and a heater to heat the flow of air produced by the air driver.

As a source of heat, preferably the apparatus comprises an electrical heater. This electrical heater is usually an electrical resistance. An electrically powered heater presents the advantage that the air pollutants produced during the roasting are pollutants generated from the heating of coffee beans themselves and not from the burning of gases as it happens when the source of heating is a gas burner using natural gas, propane, liquefied petroleum gas (LPG) or even wood.

The apparatus comprises a control system operable to control the heater and configured to apply a roasting recipe. This roasting recipe (R) provides the temperature T_{@ti}, T_{@t2}, . . . to be applied at discrete successive times t₁, t₂, . . . respectively of the roasting process. This roasting receipt is usually represented as a temperature versus time profile.

Usually, this control is implemented based on the measure of at least one temperature sensor positioned in the vessel in feedback loop control.

Control is applied on the heating device, generally on the heater and/or on the air driver.

In a specific embodiment, the control system is operable to control the air driver and is configured to apply a roasting recipe (R_{flow}) providing setpoints (F_{@ti}; ti) of fan speeds F_{@t1}, F_{@t2}, . . . to be applied at discrete successive times t₁, t₂, . . . , respectively.

When a customised quantity m of coffee beans is introduced inside the vessel, the control system of the apparatus is configured to determine the roasting recipe adapted for this specific quantity m of coffee beans.

The control system enables the roasting of any quantity of beans, in particular quantities for which no roasting recipe has been previously determined or is accessible to by the control system.

With the present apparatus, in the case of such a new quantity, the control system of the apparatus is configured to determine a roasting profile adapted to the customised quantity.

The control system of the apparatus is configured to obtain at least:
the quantity m of coffee beans introduced inside the vessel, and
the type C_{y} of coffee beans introduced inside the vessel.

In case of introduction of different types of beans with different quantities in order to create a customised blend, then each quantity for each type of beans is obtained.

The quantity m of coffee beans introduced in the chamber can be obtained:
from the user. In that case, the apparatus can comprise a user interface to enable the user to enter the quantity of beans she/he is introducing inside the chamber. This quantity can be entered through the interface of a mobile device configured to communicate with the control system of the apparatus too.

or
from a measuring device connected to the control system of the apparatus. In that case, the measure of the quantity m of the beans can be automatically provided to the control system of the apparatus.

The apparatus can comprise a measuring device configured to measure the quantity m of beans introduced in the chamber and, in the step of supplying the controller with the quantity m of coffee beans, said quantity of coffee beans can be automatically measured by the measuring device and supplied to the control system of the apparatus.

In one embodiment, the chamber of the apparatus can be transparent and the wall of the chamber can present level indicators readable by the operator.

Consequently, when the operator introduces the beans in the transparent chamber, he/she is able to read the introduced quantity by looking at the level indicator. This information can then be entered as an input inside the control system of the apparatus, for example through a user interface.

The measuring device can be:
a scale measuring weight of coffee beans, or
a device comprising at least one cavity of predetermined volume, or
a level sensor measuring a volume of coffee beans inside the chamber.

Preferably, this quantity is the weight and the measuring apparatus is a weight scale.

When the measuring device is a device comprising at least one cavity of predetermined volume, this device enables the user to select a cavity of predetermined volume and to fill this cavity completely with beans with the result that a defined volume of beans is measured. The control system of the roasting apparatus is provided with this precise volume of beans.

When the measuring device is a level sensor, this sensor measures a volume of coffee beans inside the chamber. The process control is configured to deduce the volume of beans from said measured level.

If it is the volume of beans that is measured then, based on an identification of the type C_{y} of the beans, their density can be obtained, and accordingly their precise weight can be deduced.

In a particular embodiment, the apparatus can comprise an identification device configured to read identification means from a beans package, said beans package being configured to supply the chamber of the apparatus with its whole content, and said identification means providing directly or indirectly the quantity m of beans inside the package in addition to the type of beans C_{y}.

Usually, the type C_{y} of the beans relates to at least one feature of the beans which has the direct impact on the process of roasting the beans.

The type of coffee beans can relate to specific features such as:
the origin of the beans and/or the botanical variety of the beans (Arabica, Robusta, . . . ) or a particular pre-existing mixture or blend of different beans; the pre-existing mixture or blend can be defined by the selection of different specific beans and/or by the ratio of these different specific beans.
the level of pre-roasting of the beans. The coffee beans to be roasted can be green beans or can be partially pre-roasted beans that is beans having been obtained by heating green coffee beans and stopping said heating process before the end of the first crack. These partially pre-roasted beans can be pre-roasted at different levels with a direct impact on the subsequent final roasting operated in the roasting apparatus.
the moisture of the beans,
the size of the beans.

The types of beans can refer explicitly to the nature of the beans like the origin, the botanical variety, the blend, the level of pre-roasting, . . . and/or, in a more simplest way, can be a reference like an identification number, a SKU number or a trademark.

The type of beans C_{y} can be obtained by different ways:
from the user. In that case, the user interface of the apparatus can display a list of types of beans and urge the user to select the types she/he is introducing inside the chamber. Alternatively, this list can be displayed through the interface of a mobile device configured to communicate with the control system of the apparatus.

or
from a code, such as a code provided on a beans package. In that case, the apparatus can comprise a code reader and the control system can be configured to urge the operator to scan the code of the beans (for example provided on the beans package) she/he is introducing inside the chamber.

Based on the obtained type C_{y} of the coffee beans and the obtained quantity m, the control system of the apparatus is configured to determine the recipe R_{ym} for roasting the quantity m of coffee beans of type C_{y} in the roasting apparatus according to the method described above. In particular, the control system is configured to get access at least to:
to a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and
to the list of said pre-determined quantities (M, M±Δx), and
to at least one pre-determined original roasting recipe R_{yMonginal}, said roasting recipe R_{yMonginal} being adapted to the roasting of one original pre-determined quantity M_{onginal} of beans of type C_{y} in said particular type of roasting apparatus, and
to said original pre-determined quantity M_{onginal} of beans.

This rule, this list of said pre-determined quantities (M, M±Δx), this original roasting recipe R_{yMonginal} and this pre-determined quantity M_{onginal} can be stored in a database or memory accessible to the control system of the apparatus. Further to the step of obtaining the type C_{y} of the beans, the control system can be configured to get access to them.

In an alternative embodiment, the original roasting recipe R_{yMonginal} and this pre-determined quantity M_{onginal} and eventually the rule can be encoded in a code identifying the beans C_{y}. By the single step of reading the code of the beans, the control system can be configured to obtain the identification and get access to the roasting recipe, the quantity and eventually the rule.

The original roasting recipe R_{yMonginal} accessible by the control system is adapted for a specific type C_{y} of coffee beans and for a pre-determined quantity M_{onginal} of said beans and for the present roasting apparatus. Accordingly, for one type of beans, at least one roasting recipe adapted to the roasting of said pre-determined quantity M_{onginal} is accessible to the control system.

Preferably, the pre-determined quantity M_{onginal} of this original recipe can be set to correspond to a point between the minimum quantity and the maximum quantity able to be roasted inside the chamber of the roasting apparatus.

Preferably, the control system is configured to get access to the pre-determined quantity M_{onginal} associated to the roasting recipe R_{yMonginal} too. In one embodiment, this pre-determined quantity can be the same for all the accessible original roasting recipes R_{yMonginal} whatever the beans and this pre-determined quantity M_{onginal} can be stored by the control system of the apparatus.

In another embodiment, this pre-determined quantity M_{onginal} can be different according to the coffee beans C_{y} and its roasting recipe R_{yMonginal}. In that latter case, the control system is configured to get access to said pre-determined quantity M_{onginal} associated to the respective roasting recipe R_{yMonginal} too.

In one embodiment, the apparatus is configured to receive and roast a customised quantity m of coffee beans, said customised quantity being equal either to the accessible original pre-determined quantity M or to one of the accessible pre-determined quantity M±Δx only.

With said embodiment, the apparatus is configured to receive coffee beans in a quantity selected between M and different quantities M±Δx only. These specific quantities can be the result of a particular dosing device coupled to the apparatus, such as a dosing device dispensing one specific quantity Δx at each dosing operation and able to supply the vessel with multiples of said specific quantity. Or these specific quantities can depend on the type of packages holding the beans to be roasted: supplying the vessel with beans of multiple identical packages provides a quantity corresponding to multiples of the single specific quantity hold in the package.

This embodiment enables the determination of the recipes corresponding to these specific M±Δx without the need to get access to existing roasting recipes R_{yM±Δx}: getting access to the single recipe R_{yMonginal} and to the rule is sufficient to determine the roasting recipes of this type of coffee present in other quantities M±Δx.

If the heating device of the roasting apparatus comprises an air flow driver, the control system can be operable to control said air flow driver and can be configured to apply a roasting recipe (R_{flow}) providing setpoints (F_{@ti}; ti) of an air flow F_{@t1}, F_{@t2}, . . . to be applied at discrete successive times t₁, t₂, . . . , respectively,

and

based on the obtained type C_{y} and the quantity m, the control system is configured to determine an additional roasting recipe R_{flow-ym} for roasting said quantity m of said type C_{y} coffee beans in the roasting apparatus said additional roasting recipe providing setpoints (F_{ym@ti}; ti) of an air flow F_{ym@ti}, F_{yM@t2}, . . . to be applied at discrete successive times t₁, t₂, according to the method described above.

In one embodiment, the control system can be configured to:
obtain the further use of the coffee beans to be roasted in a list of pre-determined uses (espresso, filter, French press, . . . ), and/or the desired level of roasting of the coffee beans in a list of pre-determined level (light, medium, dark),
based on the obtained specific further use and/or the obtained desired level of roasting, to get access to one pre-determined original roasting recipe R_{yMonginal}, said recipe being adapted to the roasting of one pre-determined quantity M_{onginal} of beans of type C_{y} adapted to said further use and/or the desired level of roasting.

The further use of the roasted beans relates to the process of coffee extraction to be applied to the coffee beans once they have been roasted by the roasting apparatus. This further use desired by the user can be for example: preparation of an espresso, preparation of coffee by drip filtering, by French press, preparation of a cold brewed coffee. The fact of desiring to use one of these extracted coffees to prepare a white cup by mixing with milk, creamer, . . . can be taken into account too.

The advantage is that the specific quantity m of coffee beans can be roasted to adapt the sensory profile of the resulting roasted coffee beans to this subsequent preparation.

In this embodiment where the further use and/or desired level of roasting of the roasted beans is obtained, the control system of the apparatus gets access for the same types of beans C_{y} to different roasting recipes R_{yMonginal}. One roasting recipe differs from another by the further use of the same type of beans and/or the level of roasting.

In another aspect, there is provided a system for roasting coffee beans comprising:
a roasting apparatus such as described above, and
an apparatus for measuring a quantity of coffee beans to be introduced inside the vessel, and wherein the control system of the roasting apparatus is operable to obtain the quantity m of coffee beans introduced inside the vessel and measured by the measuring apparatus.

According to a fifth aspect, there is provided a system of roasting apparatuses comprising one master roasting apparatus and a set of roasting apparatuses such as described above, said master apparatus and the roasting apparatuses of said set being of the same type, wherein:
the original roasting recipe one pre-determined original roasting recipe R_{yMonginal} is pre-determined with the master roasting apparatus, and
the rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), is defined with the master roasting apparatus.

By apparatuses of the same type, it is meant apparatuses presenting similar components to roast coffee beans, in particular:
similar vessel to contain coffee beans,
similar heating device to heat coffee beans contained in the vessel,
similar control system operable to control the heating device and configured to apply a roasting recipe (R) providing setpoints (T_{@ti}; ti) of temperatures T_{@ti}, T_{@t2} . . . to be applied at discrete successive times t₁, t₂, . . . , respectively.

According to a sixth aspect, there is provided a computer program which, when executed by a computer, processor or control unit, causes the computer, processor or control unit to perform the method the method such as described above.

Preferably the instructions of the computer program are executed by the processing unit of the roasting apparatus.

In one embodiment the instructions of the computer program can be executed by the processing unit of a device external to the coffee beans roasting apparatus, such as a mobile device, or even at a server place.

According to a seventh aspect, there is provided a computer readable storage medium comprising instructions which, when executed by a computer, processor or control unit cause the computer, processor or control unit to carry out the method such as described above.

The above aspects of the invention may be combined in any suitable combination. Moreover, various features herein may be combined with one or more of the above aspects to provide combinations other than those specifically illustrated and described. Further objects and advantageous features of the invention will be apparent from the claims, from the detailed description, and annexed drawings.

### BRIEF DESCRIPTION OF THE DRAWINGS

Specific embodiments of the invention are now described further, by way of example, with reference to the following drawings in which:

FIG. 1 is a schematic drawing of a general roasting apparatus enabling the implementation of the method of the present invention,

FIG. 2 shows a block diagram of a control system of the general apparatus according to FIG. 1,

FIGS. 3 to 5 illustrates the calculation of a new recipe for a new quantity from a pre-determined original recipe,

FIG. 6 illustrates the implementation of the method according to the invention,

FIGS. 7a to 7d schematically illustrate different embodiments of the system according to the present invention,

FIGS. 8 and 9 represent schematically methods to use systems according to the present invention.

### DETAILED DESCRIPTION OF EXEMPLARY EMBODIMENTS

Roasting Apparatus

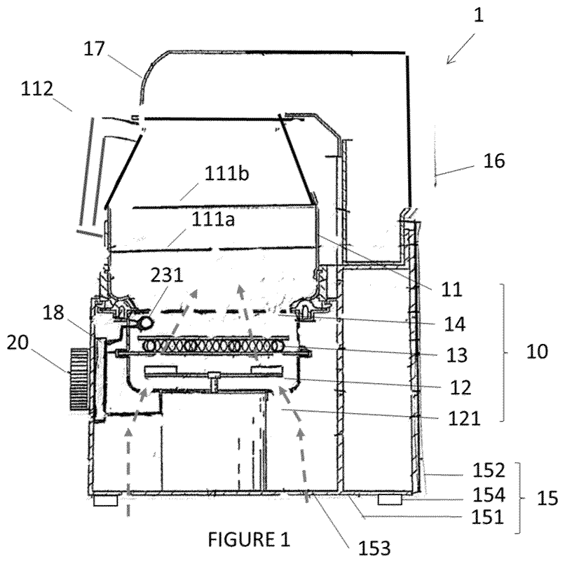

FIG. 1 shows an illustrative view part of a roasting apparatus 1. Functionally, the roasting apparatus 1 is operable to roast coffee beans hold in a vessel 11 by means of a flow of hot air introduced inside this vessel. At a first level, the apparatus comprises: a housing 15, a roasting unit 10 and a control system 180. These components will now be sequentially described.

Housing of Roasting Apparatus

The housing 15 houses and supports the aforementioned components and comprises a base 151 and a body 152. The base 151 being for abutment with a support surface, preferably through feet 154 that provide a gap between the base and the support surface. The body 152 is for mounting thereto the components.

Roasting Unit of Roasting Apparatus

The roasting unit 10 is operable to receive and roast coffee beans.

The roasting unit 10 typically comprises at a second level of the roasting apparatus 1: a vessel 11 and a heating device 12, which are sequentially described.

The vessel 11 is configured to receive and hold the coffee beans introduced by the operator.

A removable cover 17 enables the introduction and removal of beans. The bottom of the vessel is configured to enable air to pass through, specifically it can be a perforated plate 14 on which the beans can lie and through which air can flow upwardly.

A chaff collector 16 is in flow communication with the vessel 1 to receive chaffs that progressively separate from the beans and due to their light density are blown off to the chaff collector.

The vessel 11 comprises a handle 112 in order to enable the user to remove the vessel from the housing 15 and get the roasted beans.

In the illustrated embodiment the vessel 1 is at least partially transparent and comprises an upper level line 111b and a lower level line 111a designed on the vessel. Once the beans have been introduced inside the vessel 1, the user is able to check the quantity of beans introduced by reference to these levels 111a, 111b. In particular, the operator is able to check if the quantity is inferior to the lower level, between the lower and upper levels or above the upper level.

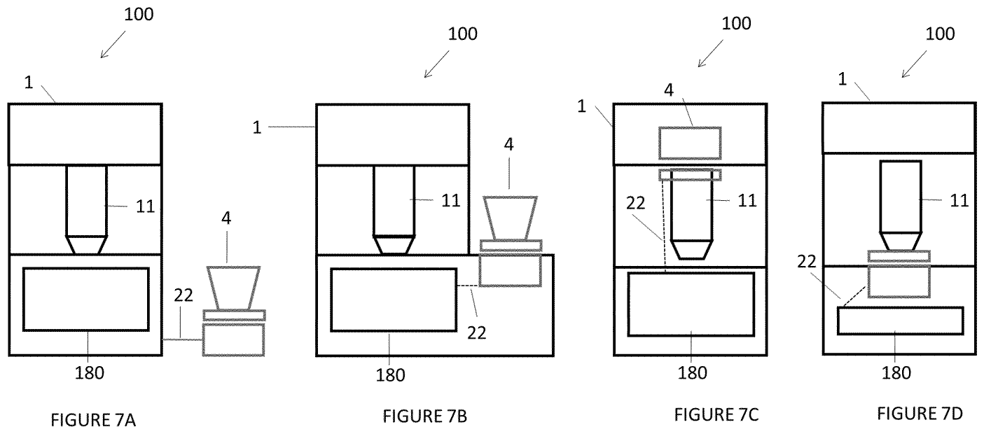

In an alternative embodiment of the roaster, illustrated in FIGS. 7b to 7d, the roasting unit can comprise a device to automatically detect the quantity of beans introduced inside the vessel 1, like a weight scale or a level sensor (capacitive or optical) inside the vessel.

In another embodiment of the roaster, not represented, the roasting unit can comprise a set of different vessels, each vessel being configured to hold a specific quantity of coffee beans. The roasting unit can comprise a vessel recognition device.

The heating device 12 comprises an air flow driver 121 and a heater 122.

The air flow driver 121 is operable to generate a flow of air in direction of the bottom of the vessel. The generated flow is configured to heat the beans and to agitate and lift the beans. As a result the beans are homogenously heated. Specifically, the air flow driver can be a fan powered by a motor 13. Air inlets 153 can be provided inside the base 151 of the housing in order to feed air inside the housing, the air flow driver blowing this air in direction of the vessel 11 as illustrated by doted lines arrows.

The heater 122 is operable to heat the flow of air generated by the air flow driver 121. In the specific illustrated embodiment, the heater is an electrical resistance being positioned between the fan and the perforated plate 14 with the result that the flow of air is heated before it enters the vessel 11 to heat and to lift the beans.

The heater 122 and/or the air flow driver 121 is/are operable to apply a roasting profile to the beans, this roasting profile being defined as a curve of temperature against time.

Although the invention is described with a roaster implementing a fluidized bed of hot air, the invention not limited to this specific type of roasting apparatus. Drum roasters and other kinds of roasters can be used.

The roasting apparatus 10 usually comprises a user interface 20 enabling the display and the input of information.

The roasting apparatus can comprise a code reader to read a code associated to a type of coffee beans, for example present on the package of coffee beans. Preferably, this code reader is positioned in the apparatus so that the operator is able to easily position a code in front of it. It is preferably positioned at the front face of the apparatus, for example close to a user interface 20 of the apparatus. Accordingly, information provided by the code can be immediately displayed through the display of the user interface 20 positioned aside.

Control System of Roasting Apparatus

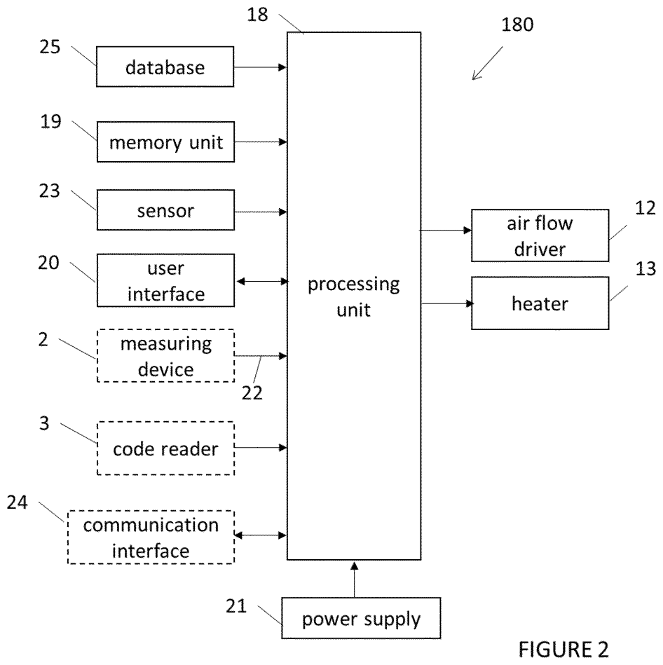

With reference to FIGS. 1 and 2, the control system 180 will now be considered: the control system 180 is operable to control the components of the roasting unit to roast coffee beans. The control system 180 typically comprises at a second level of roasting apparatus: a user interface 20, a processing unit 18, sensors 23, a power supply 21, a memory 19, optionally a communication interface 24 for remote connection, optionally a code reader 3, optionally a measuring device 4, optionally a database 25.

The user interface 20 comprises hardware to enable a user to interface with the processing unit 1, by means of user interface signal. More particularly, the user interface receives commands from a user, the user interface signal transfers the said commands to the processing unit 18 as an input. The commands may, for example, be an instruction to execute a roasting process and/or to adjust an operational parameter of the roasting apparatus 1 and/or to power on or off the roasting apparatus 1. The processing unit 18 may also output feedback to the user interface 20 as part of the roasting process, e.g. to indicate the roasting process has been initiated or that a parameter associated with the process has been selected or to indicate the evolution of a parameter during the process or to create an alarm.

In a particular embodiment, the user interface can be used:
to provide the quantity m of the coffee beans introduced inside the vessel by manual input.
to provide identification C_{y} of the coffee beans introduced inside the vessel by manual input such as selection of an identification type in a list of pre-selected coffee beans or by entering a digital reference of the coffee, for example read from a coffee beans package.
to provide the further use u_{z} of the beans introduced and to be roasted inside the vessel by manual input such as selection of the use in a list of pre-determined uses (uα, uβ, . . . ).
to provide the desired level of roasting of the beans introduced and to be roasted inside the vessel by manual input such as selection of the level in a list of pre-determined level (light, medium, dark).

The hardware of the user interface may comprise any suitable device(s), for example, the hardware comprises one or more of the following: buttons, such as a joystick button, knob or press button, joystick, LEDs, graphic or character LDCs, graphical screen with touch sensing and/or screen edge buttons. The user interface 20 can be formed as one unit or a plurality of discrete units.

A part of the user interface can also be on a mobile app when the apparatus is provided with a communication interface 24 as described below. In that case the input and output can be transmitted to the mobile device through the communication interface 24.

The sensors 23 are operable to provide an input signal to the processing unit 18 for monitoring of the roasting process and/or a status of the roasting apparatus. The input signal can be an analogue or digital signal. The sensors 23 typically comprise at least one temperature sensor 231 and optionally one or more of the following sensors: level sensor associated with the vessel 1, air flow rate sensor, position sensor associated with the vessel and/or the chaff collector.

If the apparatus or the system comprises a measuring device 24, this device is operable to provide the input 22 that is the quantity of coffee beans introduced inside the vessel 11. This input 22 can be the weight of the beans measured by a scale or a volume of beans or a level measured by a level sensor associated with the vessel 11.

A code reader 3 can be provided and operable to read a code on coffee beans package and automatically provide an input that is the identification of the coffee beans introduced in the measuring device 4 or in the vessel 11, and optionally the quantity provided by the package if the whole quantity is introduced in inside the vessel of the roasting apparatus.

The processing unit 18 generally comprise memory, input and output system components arranged as an integrated circuit, typically as a microprocessor or a microcontroller. The processing unit 18 may comprises other suitable integrated circuits, such as: an ASIC, a programmable logic device such as a PAL, CPLD, FPGA, PSoC, a system on a chip (SoC), an analogue integrated circuit, such as a controller. For such devices, where appropriate, the aforementioned program code can be considered programmed logic or to additionally comprise programmed logic. The processing unit 18 may also comprise one or more of the aforementioned integrated circuits. An example of the later is several integrated circuits is arranged in communication with each other in a modular fashion e.g.: a slave integrated circuit to control the user interface 20 in communication with a master integrated circuit to control the roasting unit 10.

The power supply 21 is operable to supply electrical energy to the said controlled components and the processing unit 18. The power supply 21 may comprise various means, such as a battery or a unit to receive and condition a main electrical supply. The power supply 21 may be operatively linked to part of the user interface 20 for powering on or off the roasting apparatus

The processing unit 18 generally comprises a memory unit 19 for storage of instructions as program code and optionally data. To this end the memory unit typically comprises: a non-volatile memory e.g. EPROM, EEPROM or Flash for the storage of program code and operating parameters as instructions, volatile memory (RAM) for temporary data storage. The memory unit may comprise separate and/or integrated (e.g. on a die of the semiconductor) memory. For programmable logic devices the instructions can be stored as programmed logic. The instructions stored on the memory unit 19 can be idealised as comprising a coffee beans roasting program.

The control system 180 is operable to apply this coffee beans roasting program by controlling the heating device 12—that is, in the particular illustrated embodiment of FIG. 1, the air flow driver 121 and/or the heater 122—usually using signal of the temperature probe 231.

The coffee beans roasting program can effect control of the said components using extraction information encoded on a code and/or other information that may be stored as data on the memory unit 19 or from a remote source through the communication interface and/or input via the user interface 20 and/or signal of the sensors 23.

In particular, the control system is configured to apply a roasting recipe R providing the temperature T_{@ti}, T_{@t2}, T_{@tfinal} to be applied at discrete successive times t₁, t₂, t_{final} respectively.

With that aim, the processing unit 18 is operable to:
receive an input of the temperature sensor 231,
process the input according to roasting recipe R,
provide an output, which is the roasting recipe R. More specifically the output comprises the operation of at least the heater 122 and the air flow driver 121.

The temperature measured by the temperature sensor 231 is used to adapt the power of the heater 122 and/or the power of the motor 13 of the air driver 121 in a feedback loop in order to apply the roasting recipe R to the beans.

Depending on the type of control applied in the roaster, the heater 122 can be powered at one pre-determined power, meaning its temperature is constant, and in that case the power of the motor 13 of the air driver 121 can be controlled based on the temperature monitored at the sensor 231 in order to vary the time of contact of the flow air through the heater during its movement.

Alternatively, the motor 13 of the air driver 121 can be powered at one pre-determined power, meaning the flow rate of air is constant, and in that case the power of the heater 122 can be controlled based on the temperature monitored at the sensor 231 in order to heat more or less air during its passage through the heating device.

In a last alternative, both heater 122 and motor 13 can be controlled based on the monitoring of the temperature by sensor 231.

In addition the control system can be configured to control the motor (13) of the air driver to apply a roasting recipe R_{flow} providing setpoints (F_{@ti}; ti) of air flow F_{@t1}, F_{@t2}, . . . to be applied at discrete successive times t₁, t₂, . . . , respectively.

Depending on the type of roasting apparatus and the air driver it comprises, the air flow can be controlled through the speed of the fan when the air driver comprises a fan with adjustable speed. Alternatively, the speed of the fan can be fixed and the flow of air can be controlled with a diaphragm or any means to control the size of air in a conduit.

The processing unit can comprise a communication interface 24 for data communication of the roasting apparatus 1 with another device and/or system, such as a server system, a mobile device and/or a physically separated measuring apparatus 2. The communication interface 24 can be used to supply and/or receive information related to the coffee beans roasting process, such as roasting process information, type of the beans, quantity of beans, further use of the beans, desired level of roasting. The communication interface 24 may comprise a first and second communication interface for data communication with several devices at once or communication via different media.

The communication interface 24 can be configured for cabled media or wireless media or a combination thereof, e.g.: a wired connection, such as RS-232, USB, 120, Ethernet define by IEEE 802.3, a wireless connection, such as wireless LAN (e.g. IEEE 802.11) or near field communication (NFC) or a cellular system such as GPRS or GSM. The communication interface 24 interfaces with the processing unit 18, by means of a communication interface signal. Generally the communication interface comprises a separate processing unit (examples of which are provided above) to control communication hardware (e.g. an antenna) to interface with the master processing unit 18. However, less complex configurations can be used e.g. a simple wired connection for serial communication directly with the processing unit 18.

The processing unit 18 enables access to:
pre-determined original roasting recipe R_{yMonginal} adapted to the roasting of one pre-determined quantity M_{original} of beans of type N_{y} in the particular type of roasting apparatus corresponding to apparatus 1, and
this pre-determined quantity M_{original} of beans,
to a rule to calculate from one roasting recipe R_{M} adapted to the roasting of one pre-determined quantity M of beans at least one roasting recipe R_{M±Δx} adapted to the roasting of at least one corresponding pre-determined quantity M±Δx of beans in the particular type of roasting apparatus corresponding to apparatus 1, and vice versa
to said at least one pre-determined quantities M and M±Δx.

These recipes, the rule and the pre-determined quantities can be stored in a memory 19 of the processing unit 18. Alternatively, these data can be stored in a remote server and the processing unit 18 can be supplied with access to this remote server through the communication interface 24, directly or indirectly through a mobile device establishing connection between the remote server and the processing unit.

These recipes and quantities can be part of a database 25 stored in the memory unit 19 or remotely as mentioned above.

In one alternative embodiment, the control system can be provided with the pre-determined original roasting recipe R_{yM} and their associated pre-determined quantities M, during a code reading operation, these pieces of information being encoded inside the code and decoded by the control system.

The code can either contain information that are directly used or can be a trigger that is can contain only an identification means which enables the control system to establish link with some parameters stored in a memory (of the roaster, of the internet cloud, of a tablet, of a smartphone app, . . . ).

The pre-determined original roasting recipe R_{yMonginal} adapted to the roasting of one pre-determined quantity M_{original} of beans of type C_{y} in the particular type of roasting apparatus corresponding to apparatus 1 provides the temperature profile to be applied to said quantity M_{original} of beans C_{y}. These temperature profiles are usually defined by experimentation by defining the optimal profile for a pre-determined quantity of beans.

The type of coffee beans C_{y} can relate to specific features such as:
the origin of the beans (Arabica, Robusta, . . . ) or a particular mixture of beans of different origins. This mixture can be defined as the blend of beans of different specific origins and by the ratio of these beans of different specific origins,
the level of pre-roasting of the beans. The coffee beans to be roasted can be green beans or can be partially pre-roasted beans that is beans having been obtained by heating green coffee beans and stopping said heating process before the end of the first crack. These partially pre-roasted beans can be pre-roasted at different levels with a direct impact on the subsequent roasting.
the moisture of the beans,
the size of the beans.

The pre-determined original roasting recipe R_{yMoriginal} roasting recipes can be adapted for a specific level of roasting like light, medium or dark. Accordingly, for one type of beans C_{y}, three different pre-determined original roasting recipes R_{yMoriginal}-light, R_{yMoriginal}-medium, R_{yMoriginal}-dark, can be accessible.

In a particular embodiment, the pre-determined original roasting recipes can be adapted for a specific further use of a quantity M of the roasted beans C_{y}. Depending on the desired use of the final roasted beans that is the way to extract a coffee beverage from the roasted beans the sensory profile of the roasted coffee beans can be adapted to this subsequent preparation.

This further use can be:
preparation of an espresso coffee with pressurised hot water,
preparation of coffee with a French press,
preparation of coffee with a drip filter,
preparation of coffee by cold brew method,
preparation of a coffee whatever the extraction with the final aim to prepare a white cup that is mixing extracted coffee with a white component such as milk, creamer, . . . , These temperature profiles are usually defined by experimentation by defining the optimal profile for the pre-determined quantity M_{original} of the specific type C_{y} of beans and for each specific further use.

The rule enables, from one first roasting recipe R_{M} adapted for a pre-determined quantity M, the calculation of another roasting recipe R_{M±Δx} adapted to the roasting of a different pre-determined quantity M±Δx.

For illustration, Table 1 below illustrates how a rule enables such a calculation. Starting from one first roasting recipe R_{M-Δ1}, R_{M} or R_{M+Δ1}, representing for example the recipes for roasting the quantities M−Δ1, M or M+Δ1 (such as 50, 150 and 250 g) respectively, of the same beans C_{y}, the table provides the rules to calculate roasting recipes for other quantities of beans.

For example, starting from the first roasting recipe R_{M}, the table provides the rule “rule(R_{M};R_{M}+R_{M+Δ1})” to calculate the recipe R_{M+Δ1}.

The rule is configured to provide the calculation in one direction from one first quantity to a second quantity. Another rule is applied to calculate the recipe for the first quantity starting from the recipe for the second quantity.

TABLE 1

| | | Quantity of beans in roasting recipe to be calculated | | |
|---|---|---|---|---|
| | [symbol] | M − Δ1 | M | M + Δ1 |
| Quantity of beans | M − Δ1 | | rule(R_{M-Δ1}; R_{M}) | rule(R_{M-Δ1}; R_{M+Δ1}) |
| in first roasting | M | rule(R_{M}; R_{M-Δ1}) | | rule(R_{M}; R_{M + Δ1}) |
| recipe | M + Δ1 | rule(R_{M+Δ1}; R_{M-Δ1}) | rule(R_{M+Δ1}; R_{M}) | |

The rule is defined by experimentation on one type of roasting apparatus, usually the master apparatus on which the original roasting recipes are pre-determined.

By roasting different quantities M−Δ1, M and M+Δ1 of beans of the same type in order to get the same final roasted beans, original roasting recipes have been determined for each quantity of said beans by a coffee expert. Then each of the roasting recipes adapted for one quantity was compared to each of the other roasting recipes adapted for other quantities and relationship between each couple of roasting recipes was established via for example well-known mathematical regression methods establishing finally the rule.

Different types of rules can be applied depending on the relationship between the recipes for different weights. The complexity of the relationship can depend on: the type of roasting apparatus such as specific construction, specific shape of the chamber, particular control rule or algorithm to control the heater (e.g. more complex if there are two degrees of control on air flow driver and heater) providing for example a more sensitive control.

The rule can also depend on the family of coffee (as mentioned below), on the level of roasting of the beans (light, medium dark) and on the further use of the roasted coffee beans (espresso, filter, . . . ).

The relation is usually determined though regression analysis and implemented by means of a regression analysis software using well-known analysis models such as linear regression, multiple regression, non-linear regression, polynomial regression, . . . .

Usually the type of rule (polynomial (e.g. linear or quadratic), logarithmic or exponential function) is the same for all the couples of original roasting recipes, but the rule itself (coefficients, sense of operations) differs from one couple to another.

Once the rules have been defined for each couple of recipes with different pre-determined weights of the same type of beans C_{y}, it has been observed that the rules are the same when the operation is repeated on the same type of apparatus with other types of beans C_{y}. Consequently, the rules defined in Table 1 applies for calculating new roasting recipes for one quantity M−Δ1, M or M+Δ1 for any type of beans roasted in the same type of roasting apparatus as the apparatus on which the rule was defined and in which the first roasting recipe was pre-determined for one of the quantity M−Δ1, M or M+Δ1.

In one embodiment, the control unit of the roasting apparatus can get access to different rules defined for different big families of beans, in particular different botanical varieties of the beans, e.g. Arabica or Robusta. Depending on the obtained type C_{y} of the beans and if this type corresponds to Arabica or Robusta variety, the corresponding rule can be accessed to.

In one particular embodiment, the type of rule is a linear function and the specific rules for calculating from one first roasting recipe R_{M} adapted for a pre-determined quantity M at least one roasting recipe R_{M±Δx} adapted to the roasting of a corresponding pre-determined quantity M±Δx of beans are specific linear functions, each of them being characterised by a corresponding couples of coefficients as illustrated in Table 2 below.

TABLE 2

| | | Quantity of beans in roasting recipe to be calculated | | |
|---|---|---|---|---|
| | [symbol] | M − Δ1 | M | M + Δ1 |
| Quantity of beans | M − Δ1 | | a(M − Δ1; M) | a(M − Δ1; M + Δ1) |
| in pre-existing | | | b(M − Δ1; M) | b(M − Δ1; M + Δ1) |
| roasting recipe | M | a(M; M − Δ1) | | a(M; M + Δ1) |
| | | b(M; M − Δ1) | | b(M; M + Δ1) |
| | M + Δ1 | a(M + Δ1; M − Δ1) | a(M + Δ1; M) | |
| | | b(M + Δ1; M − Δ1) | b(M + Δ1; M) | |

With such a rule, the roasting recipe R_{M+Δ1} to be applied on the quantity M+Δ1 of coffee beans is calculated from the first roasting recipe R_{M} applied on the pre-determined quantity M of the same type of coffee beans by using the couple of coefficients a(M;M+Δ1) and b(M;M+Δ1) and applying these coefficients to the temperatures T_{M@ti} of the roasting recipe R_{M} as follows:

T_{M+Δ1@ti}=a(M;M+Δ1)T_{m@t1}+b(M;M+Δ1)

For example, the above table was constructed with one specific master roasting apparatus in order to establish relationships between the recipes of three different weights of coffee beans: 50, 150 and 250 g. The coefficients for calculating the recipe of 250 g of coffee beans from a a first recipe set for 150 g of the same coffee beans are:

a(150;250)=0.95

b(150;250)=3

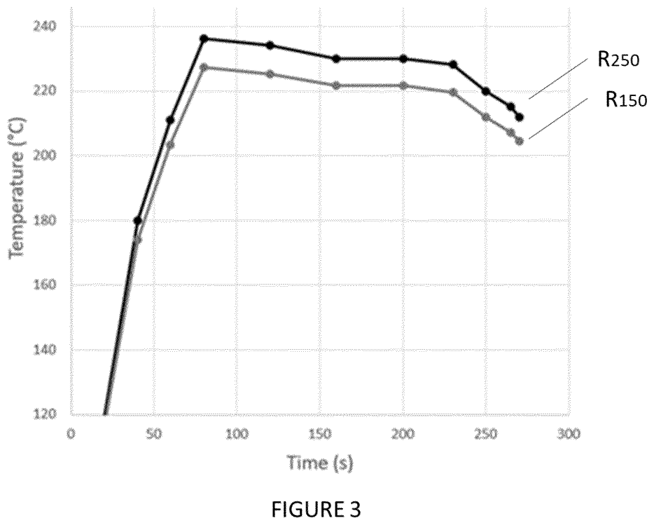

FIG. 3 illustrates the first roasting recipe R₁₅₀ for 150 g of the coffee beans pre-determined by a coffee expert on the roasting apparatus and the calculated roasting recipe R₂₅₀ derived from R₁₅₀ as follows:

T_{250@ti}=0.95T_{250@ti}+3

When the rule is linear, usually, correspondence exists between the couples of coefficients as follows:

$$a ( M - Δ x ; M ) = \frac{1}{a ( M ; M - Δ x )} and$$

$$b ( M - Δ x ; M ) = - \frac{b ( M ; M - Δ x )}{a ( M ; M - Δ x )}$$

It must be noticed that, in the preferred embodiment of the method, for all the different types C_{y} of coffee beans, it is preferred to get access to respective pre-determined original roasting recipes R_{yMonginal} adapted to the roasting of:
the same quantity M_{onginal} of beans, said quantity M_{onginal} being equal to one of the quantities of the list of pre-determined quantities (M, M±Δx) of the rule.
or to different quantities M_{onginal} of beans, said quantities M_{onginal} being equal to at least one of the quantities of the list of pre-determined quantities (M, M±Δx) of the rule.

Actually since the rule provides the way to calculate a recipe in two directions:
from recipe R_{yM} to recipe R_{yM+Δx} or R_{yM-Δx}, or
from recipe R_{yM+Δx} or R_{yM-Δx} to recipe R_{yM}, using different quantities M_{onginal} selected from the list of pre-determined quantities (M, M±Δx) is equivalent.

In one preferred embodiment, different couples of coefficients can be defined for different ranges of time of the roasting recipe. In that embodiment, the polynomial rule is defined by at least two couples of pre-determined coefficients (a_{(M;M±Δx)}; b_{(M;M±Δx)}), each of said couple being applied during a specific range of time Δti of the roasting recipe R_{yM}.

Table 3 below illustrates this particular embodiment where different coefficients are provided depending if the temperature of the roasting recipe R_{yM±Δx} is calculated for a pre-defined time t superior or inferior to td.

TABLE 3

| | | Calculated roasting recipe | | | | | |
|---|---|---|---|---|---|---|---|
| | [symbol] | M − Δ1 | | M | | M + Δ1 | |
| Pre- | M − Δ1 | | | For t < td | For t ≥ td | For t < td | For t ≥ td |
| existing | | | | a(<td)(−Δ1; M) | a(≥td)(−Δ1; M) | a(<td) (−Δ1; +Δ1) | a(≥td) (−Δ1; +Δ1) |
| roasting | | | | b(<td)(−Δ1; M) | b(≥td)(−Δ1; M) | b(<td) (−Δ1; +Δ1) | b(≥td) (−Δ1; +Δ1) |
| recipe | M | For t < td | For t ≥ td | | | For t < td | For t ≥ td |
| | | a(<td)(M; −Δ1) | a(≥td)(M; −Δ1) | | | a(<td) (M; +Δ1) | a(≥td) (M; +Δ1) |
| | | b(<td)(M; −Δ1) | b(≥td)(M; −Δ1) | | | b(<td) (M; +Δ1) | b(≥td) (M; +Δ1) |
| | M + Δ1 | For t < td | For t ≥ td | For t < td | For t ≥ td | | |
| | | a(<td)(+Δ1; −Δ1) | a(≥td)(+Δ1; −Δ1) | a(<td)(+Δ1; M) | a(≥td)(+Δ1; M) | | |
| | | b(<td)(+Δ1; −Δ1) | b(≥td)(+Δ1; −Δ1) | b(<td)(+Δ1; M) | b(≥td)(+Δ1, M) | | |

In the above example, the coefficients a_{t<100}(150; 250)=0.95 and b_{t<100}(150; 250)=3 can be set fora range of time of the roasting recipe comprised between 0 and 100 seconds. Then, above 100 seconds, the values of these coefficients become:

a_{t<100}(150;250)=0.90 and b_{t<100}(150;250)=5.

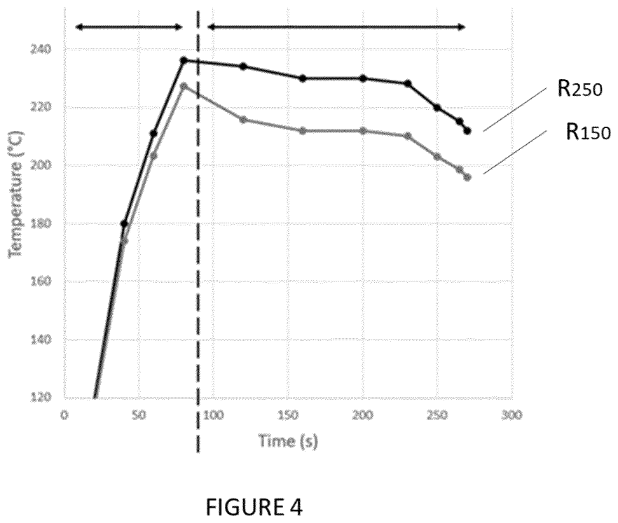

FIG. 4 illustrates the original roasting recipe R₂₅₀ obtained with this new rule.

As already mentioned, the rule can be extrapolated to other types of beans roasted in the same type of roasting apparatus. Consequently, it is sufficient to determine the rule between the recipes of one specific type of beans. Then this rule can be applied directly with other types of beans. It becomes sufficient to pre-determine only one original roasting recipe for one specific quantity of the new type of beans to be able to calculate all the roasting recipes for other quantities of said new type of beans by extrapolation.

It means that it is not necessary to pre-determine and store many original recipes for each types of beans in each roasting apparatus. Only the rule and one original roasting recipe per type of beans are sufficient.

When a customised quantity m of coffee beans is introduced inside the vessel 11 in order to be roasted, the processing unit 18 of the apparatus of the present invention is configured to implement several steps.

First, the processing unit 18 of the apparatus of the present invention is configured to obtain for beans introduced inside the vessel the quantity m of said type of coffee beans and the type C_{y} of said coffee beans.

Optionally, the processing unit is configured to obtain the desired level of roasting (light, medium, dark) and/or the future use u_{z} of the coffee beans.

As mentioned earlier, these pieces of information about identification, quantity, roasting level and use can be provided through the user interface 20 of the roasting apparatus, the display of the user interface guiding the user to enter information for each types of coffee.

Alternatively, for the identification of the coffee type, information can be obtained by means of a code reader 3, the user being able or incited to scan the code of the different beans in front of the code reader.

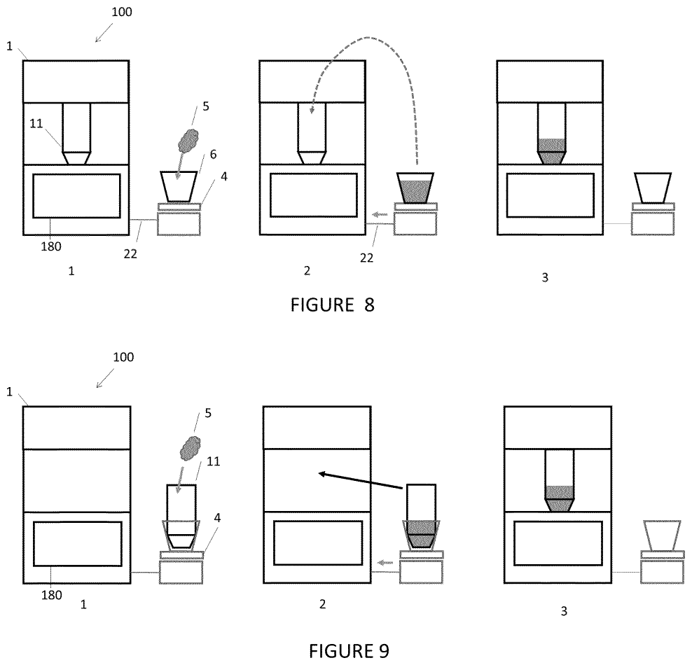

Alternatively, for the quantity of beans, the quantity can be measured and automatically communicated to the control system 180, for example by the use of a measuring device 4 directly connected to the apparatus or indirectly through the communication interface, as illustrated in FIG. 7 or 8.

Then, in a further step, the control system of the roasting apparatus is configured to get access to information related to the roasting of said coffee beans:
based on the obtained type C_{y} of coffee beans introduced inside the vessel, the control system is configured to get one pre-determined original roasting recipe R_{yMonginal} adapted to the roasting of one original pre-determined quantity M_{onginal} of said beans C_{y} in said particular type of roasting apparatus, and
to said original pre-determined quantity M_{onginal} of beans, and
to the rule to calculate the roasting recipe R_{M} or other roasting recipe(s) R_{M±Δx} adapted to the roasting of a quantity of beans comprised in a list of pre-determined quantities (M, M±Δx), from any pre-existing roasting recipe R_{M} or R_{M±Δx} adapted to the roasting of another quantity of beans in said particular type of roasting apparatus, said another quantity being comprised in the list of pre-determined quantities (M, M±Δx), and
to the list of said pre-determined quantities (M, M±Δx).

In a further step, the control system is configured to determine the roasting recipe R_{ym} to be applied on said obtained customised quantity m of coffee beans introduced inside the vessel. With that aim, the control system of the roasting is configured to compare:
m and the accessible original pre-determined quantity M_{onginal}.

and if necessary:
M_{onginal} and the accessible pre-determined quantities of the list (M, M±Δx), and
m and the accessible pre-determined quantities of the list (M, M±Δx).

to pursue the determination of the roasting recipe R_{ym}.

First, if m is equal to the accessible original pre-determined quantity M_{original}, then the roasting recipe R_{ym} is determined as the accessible original roasting recipe R_{yMoriginal}

Then, if m is not equal to the accessible original pre-determined quantity M_{original}, M_{original} is compared to the accessible pre-determined quantities of the list (M, M±Δx). Two situations can happen.

In one first case, the accessible original pre-determined quantity M_{original} can be equal to one of the accessible pre-determined quantities of the list (M, M±Δx). Then.
if the quantity m introduced in the apparatus is equal to one of the other accessible pre-determined quantities (M, M±Δx) of the list, then the roasting recipe R_{ym} is calculated by applying the rule to the accessible pre-determined original roasting recipe R_{yMoriginal}, as explained above in relation with Table 1.
if m is different from the accessible pre-determined quantities (M, M±Δx) of the list, then the roasting recipe R_{ym} is deduced from the accessible original roasting recipe R_{yMoriginal}, and/or at least one of the roasting recipes R_{yM}, R_{yM±Δx} able to be calculated by applying the rule to the accessible roasting recipe R_{yMoriginal}.

In one second case, the accessible original pre-determined quantity M_{original} is not equal to one of the accessible pre-determined quantities of the list (M, M±Δx), then the control system is configured to identify, in said list, the quantity M_{closest} presenting the smallest difference with M_{original} and deducing the corresponding roasting recipe R_{yMclosest} from the accessible roasting recipe R_{yMoriginal}.

Then, if m is different from M_{closest} but equal to one of the other accessible pre-determined quantities (M, M±Δx) of the list, the control system is configured to calculate the roasting recipe for said quantity by applying the rule to the deduced roasting recipe R_{yMclosest}. The resulting calculated recipe determines R_{ym}.

And, if m is different from any of the accessible pre-determined quantities (M, M±Δx) of the list, then the control system is configured to deduce the roasting recipe R_{ym} from the accessible original roasting recipe R_{yMoriginal}, and/or at least one of the roasting recipes R_{yM}, R_{yM±Δx} able to be calculated by applying the rule to the deduced roasting recipe R_{yMclosest}.

In the first case, where the accessible original pre-determined quantity M_{onginal} is equal to one of the accessible pre-determined quantities of the list (M, M±Δx), different manners to deduce this roasting recipe R_{ym} from the pre-determined roasting recipe R_{yM} and/or the calculable roasting recipes R_{yM±Δx} can be implemented as explained below.

In one simplest first mode, the processing unit is operable to select one roasting recipe in the list of the pre-determined roasting recipe R_{yM} and the calculable roasting recipes R_{yM}±Δx. The selection consists in identifying the roasting recipe adapted to the roasting of a pre-determined quantity of beans, in the list of M and the quantities M±Δx, that presents the smallest difference of quantity with the obtained quantity m.

For illustration, based on the above example of Table 2 with three pre-determined weights 50, 150 and 250 g, enabling the calculation of R₅₀ and R₂₅₀ from a pre-determined original roasting recipe R₁₅₀, if the customised quantity m equals 60 g, then the roasting recipe to be applied is the calculable roasting recipe R₅₀ adapted to a weight of 50 g of beans that is the closest weight to the customised weight of 60 g.

In one second mode, the processing unit 18 is operable to calculate a specific roasting recipe R_{ym} to be applied on said specific quantity m of coffee beans introduced inside the vessel from the pre-determined roasting recipe R_{yM} and/or the calculable roasting recipes R_{yM}±Δx. In a first step of determination of the roasting recipe R_{ym}, the processing unit identifies in the list of the accessible pre-determined quantities M and M±Δx, the two successive pre-determined quantities Mₘ₋₁ and Mₘ₊₁ presenting the smallest differences with m, wherein Mₘ₋₁ is inferior to Mₘ₊₁ (meaning Mm−1<m<Mₘ₊₁). For illustration, based on the above example of Table 2 with three pre-determined weights 50, 150 and 250 g, enabling the calculation of R₅₀ and R₂₅₀ from a pre-determined original roasting recipe R₁₅₀, if the customised quantity m equals 175 g, then the processing unit identifies the two successive weight 150 and 250 g with Mm−1=150 g and Mₘ₊₁=250 g.

In a further step, the processing unit obtains for said two identified quantities Mₘ₋₁ and Mₘ₊₁ the corresponding roasting recipes R_{Mm-1} and R_{Mm+1} respectively.

If one of the quantity Mₘ₋₁ or Mₘ₊₁ equals the pre-determined quantity M, then the corresponding roasting recipe R_{yM} is directly accessible by the processing unit.

If one or two of the quantities Mₘ₋₁ or Mₘ₊₁ differ(s) from M, then one or two of said quantity equal(s) one or two of the accessible pre-determined quantities M±Δx, and then the corresponding roasting recipes R_{Mm-1} and/or R_{Mm+1} can be calculated by the rule from the accessible roasting recipe R_{yM},

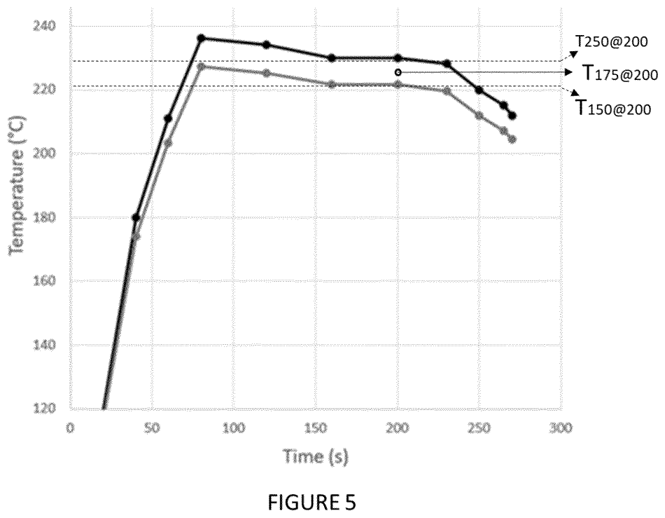

Based on the above example of Table 2, the roasting recipe for Mₘ₋₁=150 g corresponds to the pre-determined original roasting recipe R₁₅₀ and the roasting recipe R₂₅₀ for Mₘ₊₁=250 g can be calculated with the rule of Table 2 from the pre-determined original roasting recipe R₁₅₀ as mentioned above and illustrated in FIG. 4 and in FIG. 5.

In a further step, at discrete successive times t₁, t₂, . . . , t₆, the temperature Tₘ to be applied to the obtained quantity m of beans at each of said discrete successive times t₁, t₂, . . . t₆ is calculated from the obtained roasting recipes R_{Mm-1} and R_{Mm+1} as follows:

T_{m@t1}=T_{Mm-@ti}+[(T_{Mm+1@ti}−T_{Mm-1@ti})·K·(m−Mₘ₋₁)/(Mₘ₊₁−Mₘ₋₁)]

with K≤1.

With the illustration of FIG. 5, at time 200 seconds, the temperature T_{175@200} to be applied is:

T_{175@200}=T_{150@200}+[(T_{250@200}−T_{150@200})·K·(175-150)/250-150)]

The calculation is reproduced at each time t to determine the full roasting recipe R for the quantity m (175 g) of beans.

In the above formula, the coefficient K is usually fixed experimentally and can vary depending on the roaster specifications (power, vessel size, type of heater, . . . ), the type of the beans and/or the future use of the roasted beans.

In one embodiment, the coefficient K can be set according to the roaster specifications only. In another embodiment, the coefficient K can be set according to the type of beans. In that case, coefficient K can be set:
generally at a high level of definition of the beans such as the botanical variety of the beans, e.g. Arabica or Robusta providing a coefficient KA when Arabica beans are roasted and a coefficient KR when Robusta beans are roasted,
or more precisely for each type of beans C_{y} by reference to coefficient K_{y} adapted to specific type of beans C_{y} with more precise criteria than the two general origins.

In these cases, the control system is configured to obtain the type of beans (Arabica, Robusta or C_{y}) introduced in the vessel and then to get access to the coefficient KA, KR or K_{y} corresponding to that type of beans.

Preferably, the coefficient K is set according to the roaster specifications and the type of beans. In a particular embodiment, the coefficient K can be set according to the further use of the beans. In that embodiment, the coefficient K is preferably set according to the roaster specifications too and in addition, even more preferably, according to the type of beans.

In absence of information about the roaster or the type of beans or the further use, by default, the coefficient K equals 1.

In one third mode, the processing unit 18 is operable to calculate a specific roasting recipe R_{ym} to be applied on said specific quantity m of coffee beans introduced inside the vessel from the pre-determined roasting recipe R_{yM} and/or the calculable roasting recipes R_{yM±Δx} in a similar way as in the second mode, except that in the step of determination of the roasting recipe R_{ym}, the temperature Tₘ to be applied to the obtained quantity m of beans at each of said discrete successive times t₁, t₂, . . . is calculated from the obtained roasting recipes R_{Mm-1} and R_{Mm+1} as follows:
if m is closer to Mₘ₋₁, then:

T_{m@t1}=T_{Mm-@ti}+[(T_{Mm+1@ti}−T_{Mm-1@ti})·K·(m−Mₘ₋₁)/(Mₘ₊₁−Mₘ₋₁)]
if m is closer to Mₘ₊₁, then:

T_{m@t1}=T_{Mm+@ti}−[(T_{Mm+1@ti}−T_{Mm-1@ti})·K·(Mₘ₊₁−m)/(Mₘ₊₁−Mₘ₋₁)]

As a result, it means that if the quantity m is 175 g, m is closer to 150 g and the temperature to be applied at t=200 seconds is:

T_{175@200}=T_{150@200}+[(T_{250@200}−T_{150@200})·K·(175-150)/100]

But, if the quantity m is 225 g, m is closer to 250 g and the temperature to be applied at t=200 seconds is:

T_{250@200}=T_{250@200}+[(T_{250@200}−T_{150@200})·K·(250-225)/100]

In general, the quantity used in the method is the weight of beans.

If the quantity provided by the measuring device is a volume and not a weight, the weight can be deduced indirectly from an average density of coffee beans or more preferably, the identification of the nature of the beans provides access to the exact density of said beans enabling the calculation of the weight of beans introduced in the vessel.

In the step of processing the output, the processing unit 18 operates the heating device 12 usually in a closed-loop control using the input signal from the temperature sensor 231 as feedback to apply the temperature versus time profile to the coffee beans corresponding to the determined roasting recipe R_{ym}.

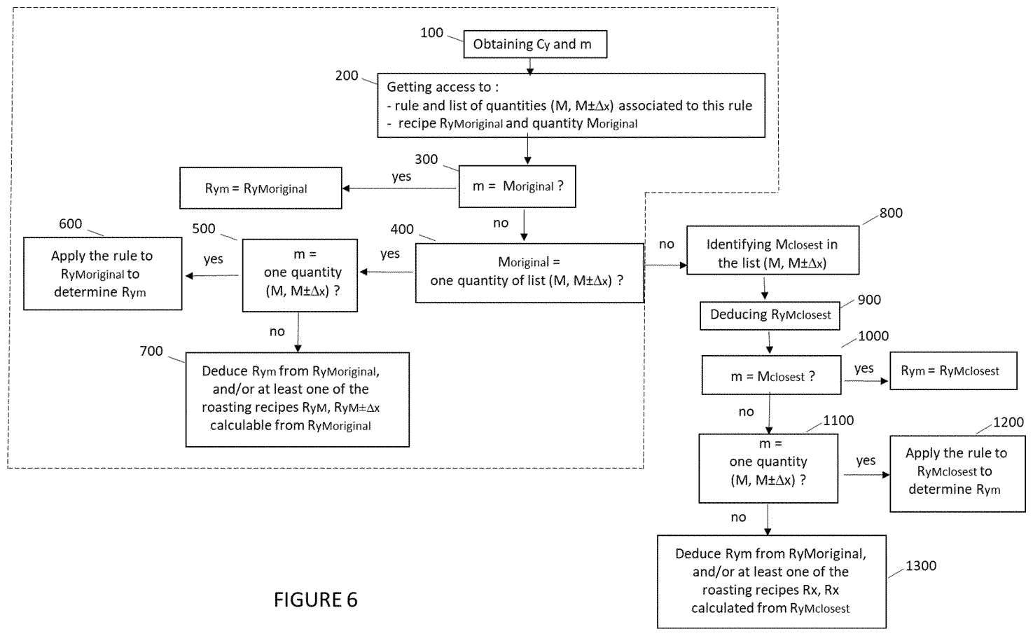

FIG. 6 illustrates the different steps of the method according to the invention and that can be implemented by the control system of a roasting apparatus in order to determine the roasting recipe R_{ym} to be applied for a customised quantity m of coffee beans of type C_{y} introduced inside the apparatus.

First, in step 100, the control system is configured to obtain the quantity m of coffee beans introduced inside the vessel and the type C_{y} of these coffee beans.

In further step 200, the control system is configured to get access:
to a rule to calculate the roasting recipe adapted to the roasting of a quantity of beans, said quantity being comprised in a list of pre-determined quantities (M, M±Δx), from any pre-existing roasting recipe adapted to the roasting of another quantity of beans in said particular type of roasting apparatus, said another quantity being comprised in the list of pre-determined quantities (M, M±Δx), and to the list of said pre-determined quantities (M, M±Δx). As mentioned above, this rule can depend on the type of beans C_{y} obtained in step 100, for example depending on the family of beans the type C_{y} belongs to. Optionally, this rule can depend on the desired level of roasting and the further use of the beans; in that cases, the desired level and the further use can be obtained at step 100 too in order to get the corresponding rule for these criteria at step 200.
to one pre-determined original roasting recipe R_{yMoriginal}, said roasting recipe R_{yMoriginal} being adapted to the roasting of one original pre-determined quantity M_{original} of beans of type C_{y} in said particular type of roasting apparatus, and to said original pre-determined quantity M_{original} of beans.

In further step 300, the control system is configured to compare m and the accessible original pre-determined quantity M_{original}.

If they are equal then the roasting recipe is the obtained pre-determined original roasting recipe R_{yMoriginal}. It must be noticed, that in this step of comparing the two quantities and checking if they are equal, the accuracy of the roasting apparatus is taken into account. In fact, for each roasting apparatus, one roasting recipe adapted to the roasting of one particular quantity M is generally adapted to the roasting of slightly different quantities, for example adapted to the roasting of quantities that are weights differing by plus or minus 1 g from the particularly adapted quantity M. In this example, it is considered that the term “equal” means “equal ±1 g”. Accordingly, in the present application, the term “equal a specific amount” can mean “equal more or less a specific amount” depending on the accuracy of the roasting apparatus.

Alternatively, in step 400, the control system is configured to compare the accessible original pre-determined quantity M_{original} and the accessible pre-determined quantities of the list (M, M±Δx).

If it is the case, then it means that the rule can be directly applied to R_{yMoriginal} in order to calculate the roasting recipes for the other pre-determined quantities (M, M±Δx) that are different from M_{original}. Then, in step 500, the quantity m is compared to the pre-determined quantities (M, M±Δx) of the list: if m is equal to one of said pre-determined quantities (M, M±Δx), then, in step 600, the roasting recipe R_{ym} can be directly calculated by applying the rule to R_{yMoriginal}.

Alternatively, if m is not equal to any of said pre-determined quantities (M, M±Δx), then, in step 700, the roasting recipe R_{ym} can be deduced from the original roasting recipe R_{yMoriginal}, and/or at least one of the roasting recipes R_{yM}, R_{yM±Δx} able to be calculated by applying the rule to the accessible roasting recipe R_{yMoriginal}.

As illustrated in dotted lines in FIG. 6, the above steps 100 to 700 corresponds to the preferred method wherein the control system is configured to get access to one original roasting recipe R_{yMoriginal} adapted to roast one original pre-determined quantity M_{original} that is equal to one of the other pre-determined quantities (M, M±Δx) of the list.

In a more complex method, it is possible that the original pre-determined quantity M_{original} is not equal to one of the other pre-determined quantities (M, M±Δx) of the list. In that case, step 800 follows step 400, where the control system is configured to identify in the list of accessible pre-determined quantities (M, M±Δx), the quantity M_{closest} presenting the smallest difference with M_{original}.

Then, in step 900, the corresponding roasting recipe R_{yMclosest} can be deduced from the roasting recipe R_{yMoriginal}. Deduction can consist in:
using R_{yMoriginal} as the roasting recipe R_{yMclosest}, or
applying a method to deduce the roasting recipe from an accessible roasting recipe such as described in WO 2020/127673. By applying this method to the current process, the roasting recipe R_{yMclosest} providing the temperature T_{Mclosest} to be applied to the quantity M_{closest} of beans at each successive times t₁, t₂, . . . is deduced as follows:
   if M_{closest}>M_{original}, then:

T_{Mclosest@ti}=T_{Moriginal@ti}+[T_{Moriginal@ti}·C·(M_{closest}−M_{original})/M_{original}]
if M_{closest}<M_{original}, then:

T_{Mclosest@ti}=T_{Moriginal@ti}+[T_{Moriginal@ti}·C·(M_{original}−M_{closest})/M_{original}]

with C≤1, and, by default, C equals 1.

This step 900 provides the approximate roasting recipe for one of the pre-determined quantities (M, M±Δx) of the list of the rule.

Then, in step 1000, the quantity m is compared to this quantity M_{closest} presenting the smallest difference with M_{original}. If m equals M_{closest} then the roasting recipe R_{ym} corresponds to said deduced roasting recipe R_{yMclosest},

If not, then, in step 1100, the quantity m is compared to the other pre-determined quantities (M, M±Δx) of the list: if m is equal to one of said other pre-determined quantities (M, M±Δx), then, in step 1200, the roasting recipe R_{ym} can be directly calculated by applying the rule to R_{yMclosest}.

Alternatively, if m is not equal to any of said pre-determined quantities (M, M±Δx), then, in step 1300, the roasting recipe R_{ym} can be deduced from the accessible original roasting recipe R_{yMoriginal}, and/or at least one of the roasting recipes R_{yM}, R_{yM±Δx} able to be calculated by applying the rule to the deduced roasting recipe R_{yMclosest}.

System

FIG. 7A illustrates a system 10 of a roasting apparatus 1 and a measuring device 4, preferably a scale. The roasting apparatus comprises a vessel 11 configured for holding beans during the roasting operation. The measuring device 2 is configured to measure the quantity of coffee beans and to communicate the measured quantity input 22 through a communication interface to the control system 180 of the roasting apparatus.

FIG. 7B illustrates an alternative system 10 of a roasting apparatus 1 and a measuring device 4, preferably a scale. The measuring device 2 is part of the roasting apparatus, precisely it is integrated in the same frame as the roasting apparatus, aside from the roasting apparatus. The measuring device 2 is configured to measure the quantity of coffee beans and to communicate the measured quantity input 22 to the control system 180 of the roasting apparatus.

FIG. 7C illustrates an alternative system 10 of a roasting apparatus 1 and a measuring device 4. The measuring device 4 is part of the roasting apparatus. In one mode, the measuring device can be a scale, and, in its roasting position, the vessel 11 can be suspended to the scale. In that mode, the vessel is weighted before the vessel is completely locked in the roasting apparatus to apply roasting.

In another mode, the measuring device can be a level sensor, and, in its roasting position, the level of beans can be measured. The measuring device 2 is configured to communicate the measured quantity as an input 22 to the control system 180 of the roasting apparatus.

FIG. 7D illustrates an alternative system 10 of a roasting apparatus 1 and a measuring device 4. The measuring device 4 is a scale that is part of the roasting apparatus. Precisely in its roasting position, the vessel 11 lays on the scale. The scale 4 is configured to weight coffee beans and to communicate the measured weight as an input 22 to the control system 180 of the roasting apparatus. Then the vessel is locked inside the roasting apparatus and roasting can be applied.

FIG. 8 illustrates a system 100 where the roasting apparatus 10 and the measuring apparatus 4 are physically separated. In this system, the coffee beans 5 are introduced and measured in an intermediate container 6 before being introduced inside the vessel 11 of the roasting apparatus 1.

This system is particularly useful when the vessel is not removable form the roaster, for example in case of drum roasters.

The measuring device 6 is connected through a cable (USB, Serial) to the roasting apparatus and is able to supply the control system of the roasting apparatus with the measured quantity of beans 22. Alternatively, the connection can be established through Wi-Fi or Bluetooth.

FIG. 9 provides an alternative embodiment of the system of FIG. 6 where the vessel 11 is removable from the roasting apparatus and can be placed on the measuring apparatus 4 in filling and measuring position before being positioned back on the roasting apparatus in a roasting position. Preferably the measuring apparatus 4 comprises a receiving area configured for holding the vessel 11 of a roasting apparatus so that it is securely hold during filling and measuring. For example, the measuring device can present an interface matching with the bottom of the vessel. Preferably, the measuring device is configured to automatically provide the weight of beans without the tare weight of the vessel.

The roasting apparatus of the present invention presents the advantage of providing the operator with flexibility in terms of quantity of beans to be roasted while guaranteeing a constant quality of roasting.

The roasting apparatus of the present invention presents the advantage of enabling the consistent reproduceable roasting of the same coffee beans in different apparatuses of the same type.

Although the invention has been described with reference to the above illustrated embodiments, it will be appreciated that the invention as claimed is not limited in any way by these illustrated embodiments.

Variations and modifications may be made without departing from the scope of the invention as defined in the claims. Furthermore, where known equivalents exist to specific features, such equivalents are incorporated as if specifically referred in this specification.

As used in this specification, the words “comprises”, “comprising”, and similar words, are not to be interpreted in an exclusive or exhaustive sense. In other words, they are intended to mean “including, but not limited to”.

List of Abbreviations:
C_{y} type of coffee beans
R_{ym} roasting recipe (temperature) adapted to the roasting of a customised quantity m of beans of type C_{y} and defined by setpoints (T_{ym@ti}; ti)
R_{yMoriginal} pre-determined original roasting recipe (temperature) adapted to the roasting of one pre-determined quantity M_{original} of beans of type C_{y}
M_{original} original pre-determined quantity
M, M±Δx pre-determined quantities
R_{yM±Δx} calculated roasting recipe (temperature) adapted to the roasting of one pre-determined quantity M±Δx of beans of type C_{y}
M_{closest} quantity from the list of M and M±Δx and presenting the smallest difference with M_{original}
R_{yMclosest} deduced roasting recipe adapted to the roasting of the quantity M_{closest}
Mₘ₋₁ quantity from the list of M and M±Δx, inferior to m and presenting the smallest difference with m
Mₘ₊₁ quantity from the list of M and M±Δx, superior to m and presenting the smallest difference with m
R_{Mm-1} roasting recipe (temperature) adapted to the roasting of the quantity Mₘ₋₁
R_{Mm+1} roasting recipe (temperature) adapted to the roasting of the quantity Mₘ₊₁
R_{flow-ym} roasting recipe (fan speed) adapted to the roasting of a customised quantity m of beans of type C_{y} and defined by setpoints (S_{ym@ti}; ti)
R_{flow-yM} pre-determined original roasting recipe (fan speed) adapted to the roasting of one pre-determined quantity M of beans of type C_{y}
R_{flow-yM}±Δx calculated roasting recipe (fan speed) adapted to the roasting of one pre-determined quantity M±Δx of beans of type C_{y}

### LIST OF REFERENCES IN THE DRAWINGS

roaster 1
roasting unit 10
vessel 11
levels 111a, 111b
handle 112
heating device 12
air flow driver 121
heater 122
motor 13
perforated plate 14
housing 15
base 151
body 152
air inlet 153
feet 154
chaff collector 16
cover 17
processing unit 18
control system 180
memory 19
user interface 20
power supply 21
measured quantity input 22
sensor 23
temperature sensor 231
communication interface 24
database 25
measuring device 2
measured quantity input 22
code reader 3
measuring device 4
coffee beans 5
intermediate container 6
system 100

1. A method to determine the recipe Rym for roasting a quantity m of a type C_{y} of coffee beans in a particular type of roasting apparatus, said recipe R_{ym} providing setpoints (T_{ym@ti}; ti) of temperatures T_{ym@t}_{₂}, T_{ym@t}_{₂}, . . . to be applied at discrete successive times t₁, t₂, . . . , respectively,
wherein the method comprises the steps of:
getting access:
to a rule to calculate the roasting recipe adapted to the roasting of a quantity of beans, said quantity being comprised in a list of pre-determined quantities (M, M+Δx), from any pre-existing roasting recipe adapted to the roasting of another quantity of beans in said particular type of roasting apparatus, said another quantity being comprised in the list of pre-determined quantities (M, M+Δx), and
to the list of said pre-determined quantities (M, M+Δx), and
to at least one pre-determined original roasting recipe R_{yMoriginal}, said roasting recipe R_{yMoriginal} being adapted to the roasting of one original pre-determined quantity M_{original} of beans of type C_{y} in said particular type of roasting apparatus, said pre-determined original roasting recipe R_{yMoriginal} providing setpoints (T_{yMoriginal@ti}; ti) of temperatures T_{yMoriginal}_{_{@}}ₜ_{₁}, T_{yMoriginal}_{_{@}}ₜ_{₂}, . . . to be applied at discrete successive times t₁, t₂, . . . , respectively, and
to said original pre-determined quantity M_{original} of beans, and
based on:
the comparison between m and the accessible original pre-determined quantity M_{original}, and
the comparison between M_{original} and the accessible pre-determined quantities of the list (M, M+Δx), and
the comparison between m and the accessible pre-determined quantities of the list (M, M±Δx)
determining the roasting recipe R_{ym} to be applied on said quantity m of coffee beans as follows:
if m is equal to the accessible original pre-determined quantity M_{original}, then the roasting recipe R_{ym} corresponds to the accessible original roasting recipe R_{yMoriginal},
if m is different from the accessible original pre-determined quantity M_{original}, and
if the accessible original pre-determined quantity M_{original} is equal to one of the accessible pre-determined quantities of the list (M, M+Δx), and
if m is equal to one of the other accessible pre-determined quantities (M, M+Δx) of the list, then the roasting recipe R_{ym} is calculated by applying the rule to the accessible pre-determined original roasting recipe R_{yMoriginal},
if m is different from the accessible pre-determined quantities (M, M+Δx) of the list, then the roasting recipe R_{ym} is deduced from the accessible pre-determined original roasting recipe R_{yMoriginal}, and/or at least one of the roasting recipes R_{yM}, R_{yM±Δx} able to be calculated by applying the rule to the accessible pre-determined roasting recipe R_{yMoriginal},
if M_{original} is different from any of the accessible pre-determined quantities of the list (M, M+Δx), then identifying, in said list, the quantity M_{closest} presenting the smallest difference with M_{original} and deducing the corresponding roasting recipe R_{yMclosest} from the accessible pre-determined roasting recipe R_{yMoriginal}, and then:
if m is equal to said quantity M_{closest} presenting the smallest difference with M_{original}, then the roasting recipe R_{ym} corresponds to said deduced roasting recipe R_{yMclosest},
if m is different from M_{closest} but equal to one of the other accessible pre-determined quantities (M, M+Δx) of the list, then the roasting recipe R_{ym} is calculated by applying the rule to the deduced roasting recipe R_{yMclosest},
if m is different from any of the accessible pre-determined quantities (M, M+Δx) of the list, then the roasting recipe R_{ym} is deduced from the accessible original roasting recipe R_{yMoriginal}, and/or at least one of the roasting recipes R_{yM}, R_{yM±Δx} able to be calculated by applying the rule to the deduced roasting recipe R_{yMclosest}.

2. A method according to claim 1, wherein the rule is a mathematical function, such as a polynomial, logarithmic or exponential function, applied to the temperatures T_{@ti} of the setpoints of the pre-existing roasting recipe adapted to the roasting of another quantity of beans comprised in the list of pre-determined quantities (M, M+Δx).

3. A method according to claim 2, wherein the rule to calculate from one pre-existing roasting recipe R_{M} (TM_{@ti}; tᵢ) adapted to the roasting of a pre-determined quantity M of beans at least one roasting recipe R_{M±Δx} (T_{M+Δx}@ti; ti) adapted to the roasting of a pre-determined quantity M±Δx of beans is a linear function,
said rule being defined by at least one couple of pre-determined coefficients (a_{(M;M+Δx)}; b_{(M;M+Δx)}), said coefficients being specific to the difference of quantity ±Δx, and said rule being applied to the temperatures T_{yM@ti} provided by the pre-determined original roasting recipe R_{M} as follows:
T_{yM±Δx@ti}=a_{(M;M±Δx)}T_{yM@ti}+b_{(M;M±Δx)}.

4. A method according to the claim 3, wherein said polynomial rule is defined by at least two couples of pre-determined coefficients (a_{(M;M±Δx)}; b_{(M;M±Δx)}), each of said couple being applied during a specific range of time Δti of the pre-determined roasting recipe R_{yM}.

5. A method according to claim 2, wherein the accessible original pre-determined quantity M_{original} is equal to one of the accessible pre-determined quantities of the list (M, M±Δx) of the rule.

6. A method according to claim 5, wherein, if m is different from the accessible original pre-determined quantity M and from any of the accessible pre-determined quantities M±Δx, then the roasting recipe R_{ym} to be applied on said obtained quantity m of coffee beans introduced inside the vessel is deduced from one or two of the accessible roasting recipe R_{yM} and/or the calculable roasting recipes R_{yM}±Δx, each of said one or two recipes being adapted to the roasting of one pre-determined quantity of beans respectively and said pre-determined quantity or quantities of beans presenting the smallest difference(s) of quantity with the obtained quantity m.

7. A method according to claim 6, wherein the roasting recipe R_{ym} to be applied on said obtained quantity m of coffee beans introduced inside the vessel is deduced by selecting in the list of the accessible original roasting recipe R_{yM} and/or the calculable roasting recipes R_{yM}±Δx, the roasting recipe adapted to the roasting of one pre-determined quantity of beans presenting the smallest difference of quantity with the obtained quantity m.

8. A method according to claim 6, wherein the roasting recipe R_{ym} to be applied on said obtained quantity m of coffee beans introduced inside the vessel is deduced by:
identifying in the list of the accessible pre-determined quantities M and M±Δx, the two successive pre-determined quantities Mₘ₋₁ and Mₘ₊₁ presenting the smallest differences with m, wherein Mₘ₋₁ is inferior to Mₘ₊₁,
for said two identified quantities Mₘ₋₁ and Mₘ₊₁, obtaining the corresponding roasting recipe R_{Mm-1} and R_{Mm+1} respectively, said recipes being determined as follows:
if one of the identified quantities Mₘ₋₁ or Mₘ₊₁ is equal to the original pre-determined quantity M, then getting access to the pre-determined original roasting recipe R_{yM} adapted to the roasting of said pre-determined quantity M of beans,
if one or two of said identified quantities Mₘ₋₁ and/or Mₘ₊₁ differ(s) from the original pre-determined quantity M, then calculating the corresponding roasting recipes R_{Mm-1} and/or R_{Mm+1} by applying the rule to the accessible original roasting recipe R_{yM},
from the obtained roasting recipes R_{Mm-1} and R_{Mm+1}, said recipes providing the temperatures T_{Mm-1@t1}, T_{Mm-1 @t2}, . . . , . . . and T_{Mm+1@t1}, T_{Mm+1@t2}, . . . respectively applied at discrete successive times t₁, t₂, . . . , determining the temperature T_{m@t1}, T_{m@t2}, . . . to be applied to the obtained quantity m of beans at each of said discrete successive times ti₁ t₂, . . . as follows:
T_{m@t1}=T_{Mm-1@ti}+[(T_{Mm+1@ti}−T_{Mm-1@ti})·K·(m−Mₘ₋₁)/(Mₘ₊₁−Mₘ₋₁)]
with K≤1.

9. A method according to claim 6, wherein the roasting recipe R_{ym} to be applied on said obtained quantity m of coffee beans introduced inside the vessel is deduced by:
identifying in the list of the accessible pre-determined quantities M and M+Δx, the two successive pre-determined quantities Mₘ₋₁ and Mₘ₊₁ presenting the smallest differences with m,
for said two identified quantities Mₘ₋₁ and Mₘ₊₁ obtaining the corresponding roasting recipe R_{Mm-1} and R_{Mm+1} respectively, said recipes being determined as follows:
if one of the identified quantities Mₘ₋₁ or Mₘ₊₁ is equal to the pre-determined quantity M, then getting access to the pre-determined original roasting recipe R_{yM} adapted to the roasting of said pre-determined quantity M of beans,
if one or two of said identified quantities Mₘ₋₁ and/or Mₘ₊₁ differ(s) from the original pre-determined quantity M, then calculating the corresponding roasting recipes R_{Mm-1} and/or R_{Mm+1} by applying the rule to the accessible original roasting recipe R_{yM},
from the obtained roasting recipes R_{Mm-1} and R_{Mm+1}, said recipes providing the temperatures T_{Mm-1@t1}, T_{Mm-1@t2}, . . . and T_{Mm+1@t1}, T_{Mm+1@t2}, . . . respectively applied at discrete successive times t₁, t₂, . . . , determining the temperature T_{m@t1}, T_{m@t2}, . . . to be applied to the obtained quantity m of beans at each of said discrete successive times t₁, t₂, . . . as follows:
if m is closer to Mₘ₋₁, then:
T_{m@t1}=T_{Mm-1@ti}+[(T_{Mm+1@ti}−T_{Mm-1@ti})·K·(m−Mₘ₋₁)/(Mₘ₊₁−Mₘ₋₁)]
if m is closer to Mₘ₊₁, then:
T_{m@t1}=T_{Mm-1@ti}−[(T_{Mm+1@ti}−T_{Mm-1@ti})·K·(Mₘ₊₁−m)/(Mₘ₊₁−Mₘ₋₁)]
with K≤1.

10. A method according to claim 6, wherein the roasting recipe R_{ym} to be applied on said obtained quantity m of coffee beans introduced inside the vessel is deduced by:
identifying in the list of the accessible original pre-determined quantities M and M+Δx, the two successive pre-determined quantities Mₘ₋₁ and Mₘ₊₁ presenting the smallest differences with m, wherein Mₘ₋₁ is inferior to Mₘ₊₁,
for said two identified quantities Mₘ₋₁ and Mₘ₊₁, obtaining the corresponding at least one couple of pre-determined coefficients (a_{(M;Mm-1)};b_{(M;Mm-1)}) and (a_{(M;Mm+1)};b_{(M;Mm+1)}), wherein if one said two identified quantities Mₘ₋₁ and Mₘ₊₁ is equal to M, then the corresponding couple of pre-determined coefficients is (1;1),
from said obtained couples of pre-determined coefficients (a_{(M;Mm-1)};b_{(M;Mm-1)}) and (a_{(M;Mm+1)};b_{(M;Mm+1)}), determining at least one couple of coefficients a_{(M;m)} as follows:
a_{(M;m)}=a_{(M;Mm-1)}+[(a_{(M;Mm+1)}−a_{(M;Mm-1)})·K·(m−Mₘ₋₁)(Mₘ₊₁−Mₘ₋₁)]
with K≤1,
from said determined at least one couple of coefficients a_{(M;m)} and from the pre-determined original roasting recipe R_{yM} (T_{yM@ti}; ti), calculating the roasting recipe R_{ym} providing the temperature T_{m@t1}, T_{m@t2}, . . . to be applied to the obtained quantity m of beans at each of said discrete successive times t₁, t₂, . . . as follows:
T_{ym@ti}=a_{(M;m)}T_{yM@ti}+b_{(M;m)}.

11. A method according to claim 1 wherein said method is applied in a specific roasting apparatus comprising an air flow driver, wherein said method enables the determination of an additional roasting recipe R_{flow-ym} for roasting a quantity m of a type C_{y} coffee beans in a roasting apparatus said additional roasting recipe providing setpoints (F_{ym@ti}; ti) of an air flow F_{@t1}, F_{@t2}, . . . to be applied at discrete successive times ti₁ t₂,
wherein the method comprises the steps of:
getting access:
to a rule to calculate the roasting recipe adapted to the roasting of a quantity of beans, said quantity being comprised in a list of pre-determined quantities (M, M+Δx), from any pre-existing roasting recipe adapted to the roasting of another quantity of beans in said particular type of roasting apparatus, said another quantity being comprised in the list of pre-determined quantities (M, M+Δx), and
to the list of the pre-determined quantities (M, M+Δx), and
to at least one pre-determined original roasting recipe R_{flow-yMoriginal}, said roasting recipe R_{flow-yMoriginal} being adapted to the roasting of one original pre-determined quantity M_{original} of beans of type C_{y} in said particular type of roasting apparatus, and
to said original pre-determined quantity M_{original} of beans, and
based on:
the comparison between m and the accessible original pre-determined quantity M_{original} and on the comparison between m and the accessible pre-determined quantities of the list (M, M±Δx) and
the comparison between M_{original} and the accessible pre-determined quantities of the list (M, M+Δx)
determining the roasting recipe R_{flow-ym} to be applied on said quantity m of coffee beans as follows:
if m is equal to the accessible original pre-determined quantity M_{original}, then the roasting recipe R_{flow ym} corresponds to the accessible original roasting recipe R_{flow-yMoriginal},
if m is different from the accessible original pre-determined quantity M_{original}, and
if the accessible original pre-determined quantity M_{original} is equal to one of the accessible pre-determined quantities of the list (M, M+Δx), and
if m is equal to one of the other accessible pre-determined quantities (M, M+Δx) of the list, then the roasting recipe R_{flow ym} is calculated by applying the rule to the accessible pre-determined original roasting recipe R_{flow-yMoriginal},
if m is different from the accessible pre-determined quantities (M, M+Δx) of the list, then the roasting recipe R_{flow-ym} is deduced from the accessible original roasting recipe R_{flow-yMoriginal}, and/or at least one of the roasting recipes R_{flow-yM}, R_{flow yM±Δx} able to be calculated by applying the rule to the accessible roasting recipe R_{flow-yMoriginal},
if M_{original} is different from any of the accessible pre-determined quantities of the list (M, M±Δx), then identifying, in said list, the quantity M_{closest} presenting the smallest difference with M_{original} and deducing the corresponding roasting recipe R_{flow-yMclosest} from the accessible roasting recipe R_{flow-yMoriginal}, and then:
if m is equal to said quantity M_{closest} presenting the smallest difference with M_{original}, then the roasting recipe R_{flow-ym} corresponds to deduced roasting recipe R_{flow-yMclosest},
if m is different from M_{closest} but equal to one of the other accessible pre-determined quantities (M, M±Δx) of the list, then the roasting recipe R_{flow-ym} is calculated by applying the rule to the deduced roasting recipe R_{flow-yMclosest},
if m is different from any of the accessible pre-determined quantities (M, M±Δx) of the list, then the roasting recipe R_{flow-ym} is deduced from the accessible original roasting recipe R_{flow-yMoriginal}, and/or at least one of the roasting recipes R_{flow-yM}, R_{flow-yM}±Δx able to be calculated by applying the rule to the deduced roasting recipe R_{flow-yMclosest}.

12. Method according to claim 1, wherein the rule to calculate from one pre-determined roasting recipe R_{flow-yM} (F_{yM}_{_{@ti}}; ti) adapted to the roasting of a pre-determined quantity M of beans at least one roasting recipe R_{flow-yM±Δx} (F_{yM±Δx} @ti; ti) adapted to the roasting of a pre-determined quantity M+Δx of beans is a polynomial function,
said rule being defined by a couple of pre-determined coefficients (c_{(M;M+Δx)}; d_{(M;M+Δx)}) and being applied to the air flow provided by the pre-determined roasting recipe R_{fnlow-M} as follows:
F_{yM±Δx}@ti=c_{(M;M±Δx)}F_{yM@ti}+d_{(M;M±Δx)}

13. (canceled)

14. A method to determine the recipe R_{blend} for roasting a customised blend of coffee beans C_{A}, C_{B}, . . . with respective quantities mA, mB, . . . of said coffee beans in a particular type of roasting apparatus, said recipe R_{blend} providing setpoints (T_{blend@ti}; ti) of temperatures T_{blend@t1}, T_{blend@t2}, . . . to be applied at discrete successive times t₁, t₂, . . . , respectively, wherein the method comprises the steps of:
for each type of coffee beans C_{y} part of the blend, determining the roasting recipe R_{ym} to be applied on said quantity my of coffee beans,
getting access to temperature adaptation factors X_{y} of said different types of coffee beans C_{y} respectively of the customised blend,
from said determined roasting recipes R_{ym} and from said accessible temperature adaptation factors X_{y}, and based on the quantities my of beans of type C_{y}, determining the temperature T_{blend@t1}, T_{blend@t2}, . . . , to be applied to the customised blend of beans at each of discrete successive times t₁, t₂, . . . respectively according to following formula (I):
$${T}_{blend @ {t}_{i}} = {\sum }_{y} {f}_{y} \cdot {X}_{y} \cdot {T}_{{m}_{y} @ {t}_{i}} \qquad ( I )$$
wherein y corresponds to all the types of coffee beans present in the blend and f_{y} represents the fraction in weight of coffee beans of type C_{y} in the blend of coffee beans.

15. A method to determine the recipe R_{blend} for roasting a customised blend of coffee beans of different types C_{y} with respective quantities my of said coffee beans in a particular type of roasting apparatus, said recipe R_{blend} providing setpoints (T_{blend@ti}; ti) of temperatures T_{blend@t1}, T_{blend@t2}, . . . to be applied at discrete successive times t₁, t₂, respectively, wherein the method comprises the steps of:
getting access:
for each types of coffee beans C_{y} comprised in the blend, to at least one pre-determined original roasting recipes R_{yMoriginal} respectively, each recipe R_{yMoriginal} (T_{yMoriginal}_{_{@ti}}; tᵢ) being adapted to the roasting of one original pre-determined quantity Moriginal of beans of type C_{y} in said particular type of roasting apparatus,
to said original pre-determined quantity M_{original} of beans, and
to a rule to calculate from one pre-determined original roasting recipe R_{yMoriginal} (T_{yMoriginal@ti}; tᵢ) at least one roasting recipe R_{Moriginal+Δx} adapted to the roasting of a pre-determined quantity M_{original±Δx} of beans in said particular type of roasting apparatus, said rule being a linear function, and said being defined by at least one couple of pre-determined coefficients (a(M_{original};M_{original+Δx}); b(M_{original}; M_{original +Δx})), said coefficients being specific to the difference of quantity ±Δx, and said rule being applied to the temperatures T_{Moriginal@ti} provided by one pre-determined original roasting recipe R_{Moriginal} as follows:
T_{Moriginal±Δx}@ti=a_{(Moriginal;Moriginal±@x)}T_{Moriginal@ti}+b_{(Moriginal;Moriginal±Δx)}
and
to said at least one pre-determined quantity M_{original+Δx}, and
to temperature adaptation factors X_{y} of said different types of coffee beans C_{y} respectively,
and
for each type of coffee beans C_{y} part of the blend, identifying in the list of pre-determined quantities M_{original} and M_{original+Δx} the quantity M_{closest} presenting the smallest difference with my and deducing the corresponding couple of coefficients (a_{y}:b_{y}) as follows:
a_{y}=a_{(Moriginal;Mclosest)};
b_{y}=b_{(Moriginal;Mclosest)},
calculating the corresponding couple of coefficients of the blend as follows:
$${a}_{b l e n d} = {\sum }_{y} {f}_{y} \cdot {a}_{y}$$
$${b}_{blend} = {\sum }_{y} {f}_{y} \cdot {b}_{y}$$
wherein y corresponds to all the types of coffee beans present in the blend and f_{y} represents the fraction in weight of coffee beans of type C_{y} in the blend of coffee beans,
determining the temperature T_{blend@t1}, T_{blend@t2}, . . . , to be applied to the customised blend of beans at each of discrete successive times t₁, t₂, . . . respectively according to following formula (II):
$${T}_{blend @ {t}_{i}} = {a}_{blend} ( {\sum }_{y} {f}_{y} \cdot {X}_{y} \cdot {T}_{yMoriginal @ ti} ) + {b}_{blend} \qquad ( II )$$
wherein y corresponds to all the types of coffee beans present in the blend and f_{y} represents the fraction in weight of coffee beans of type C_{y} in the blend of coffee beans.

16-22. (canceled)
